(19) United States
(12) Patent Application Publication
(10) Pub. No.: US 2026/0289122 A1
(43) Pub. Date: Sep. 24, 2026

(54) SYSTEM

(71) Applicant: SoftBank Group Corp., Tokyo (JP)

(72) Inventor: Daisuke TANAKA, Tokyo (JP)

(73) Assignee: SoftBank Group Corp., Tokyo (JP)

(21) Appl. No.: 19/564,247

(22) Filed: Mar. 12, 2026

(30) Foreign Application Priority Data
Mar. 19, 2025 (JP) 2025-044895

(51) Int. Cl. G06F 40/284; G06F 16/215; G06F 40/186; G06N 3/0475

(52) U.S. Cl. CPC G06F 40/284; G06F 16/215; G06F 40/186; G06N 3/0475

(57) ABSTRACT

A system includes a processor, wherein the processor is configured to provide an interface for inputting information, receive and store information input via the interface, generate a prompt for instructing a generative AI model to generate a promotional text based on the stored information, and input the prompt into the generative AI model to automatically generate the promotional text.

### CROSS-REFERENCE TO RELATED APPLICATION

This application is based on and claims priority under 35 USC 119 from Japanese Patent Application No. 2025-044895 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for creating promotional texts for products, services, or content rely heavily on manual work performed by human creators or marketers. In such techniques, a human operator generally gathers raw information, drafts promotional copy, and revises the text into a form suitable for promotional communications or advertising displays. This manual workflow is time-consuming, requires specialized writing skills, and is difficult to scale when a large volume of promotional texts must be produced in a short period. Furthermore, even when generative AI models are employed, the construction of effective prompts and the management of generated outputs are often handled manually, resulting in unstable quality and additional operational burden. In addition, conventional systems do not sufficiently leverage evaluation results of generated texts to automatically update model parameters and continuously improve the generation method. Therefore, there is a need for a system that can automatically generate promotional texts in a format usable for promotional communications and advertising displays, while also enabling continuous improvement of the text generation method based on evaluation indicators, thereby reducing manual workload and stabilizing and enhancing the quality of promotional texts.

### SUMMARY

In order to solve at least part of the above-described problems, an aspect of the present invention provides a system comprising a processor, wherein the processor is configured to provide an interface for inputting information, receive and store information input via the interface, generate a prompt for instructing a generative AI model to generate a promotional text based on the stored information, and input the prompt into the generative AI model to automatically generate the promotional text. The processor may be further configured to cause the promotional text automatically generated using the generative AI model to be in a format usable in promotional communications or advertising displays, for example, by applying formatting rules or output constraints corresponding to predetermined media channels. The processor may also be configured to update parameters of the generative AI model based on measurement results of evaluation indicators relating to the automatically generated promotional text, and thereby improve a method of generating the promotional text. As a result, the system can automate the generation of promotional texts, output the texts in practically usable formats, and iteratively enhance the generation performance by feedback based on evaluation metrics.
The term “system” refers to a combination of one or more hardware and software components that cooperate to perform the processing specified in the claims, including at least one processor and any associated memory, storage, interfaces, and programs.
The term “processor” refers to any hardware processing unit or units, such as a central processing unit (CPU), graphics processing unit (GPU), microcontroller, or dedicated logic circuitry, that executes instructions to perform the functions specified in the claims.
The term “interface for inputting information” refers to any hardware and/or software component that enables a user, another system, or an external device to input information into the system, including but not limited to graphical user interfaces, web forms, application programming interfaces (APIs), and communication ports.
The term “information input via the interface” refers to data provided to the system through the interface for inputting information, such as product descriptions, service information, campaign details, target audience descriptions, or other content used as a basis for generating promotional text.
The term “store” refers to the act of recording information in a memory or storage device, such as volatile memory, non-volatile memory, or external storage, such that the information can be subsequently accessed and processed by the processor.
The term “prompt” refers to data representing an instruction or set of instructions, including contextual information and constraints, supplied to a generative AI model to cause the generative AI model to generate a promotional text based on stored information.
The term “generative AI model” refers to a machine learning model, such as a neural network-based language model, that is trained to generate text outputs in response to input prompts, and that produces promotional texts according to the instructions and context included in the prompts.
The term “promotional text” refers to text generated by the generative AI model for the purpose of promoting products, services, content, events, or brands, including but not limited to advertising copy, marketing messages, campaign descriptions, or announcement texts.
The term “automatically generate” refers to causing the generative AI model to produce the promotional text without requiring manual drafting of the promotional text by a human operator, based on the prompt and stored information.
The term “format usable in promotional communications or advertising displays” refers to a structure, style, or layout of the promotional text that is suitable for direct or substantially direct use in promotional channels, including but not limited to email newsletters, social media posts, online advertisements, banner ads, and printed advertisements.
The term “evaluation indicators” refers to one or more quantitative or qualitative metrics used to assess the performance or quality of the promotional text, such as click-through rate, conversion rate, engagement rate, readability score, user rating, or other predefined evaluation measures.
The term “measurement results of evaluation indicators” refers to data representing measured values or outcomes associated with the evaluation indicators, obtained from actual use, testing, or simulation of the promotional text in one or more promotional channels.
The term “parameters of the generative AI model” refers to adjustable values within the generative AI model, including but not limited to weights, biases, hyperparameters, or other internal settings that influence how the generative AI model generates the promotional text.
The term “improve a method of generating the promotional text” refers to modifying the generative AI model or its operation, based on the measurement results of evaluation indicators, so as to enhance one or more aspects of the generated promotional text, such as effectiveness, relevance, engagement, or compliance with desired styles or constraints.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

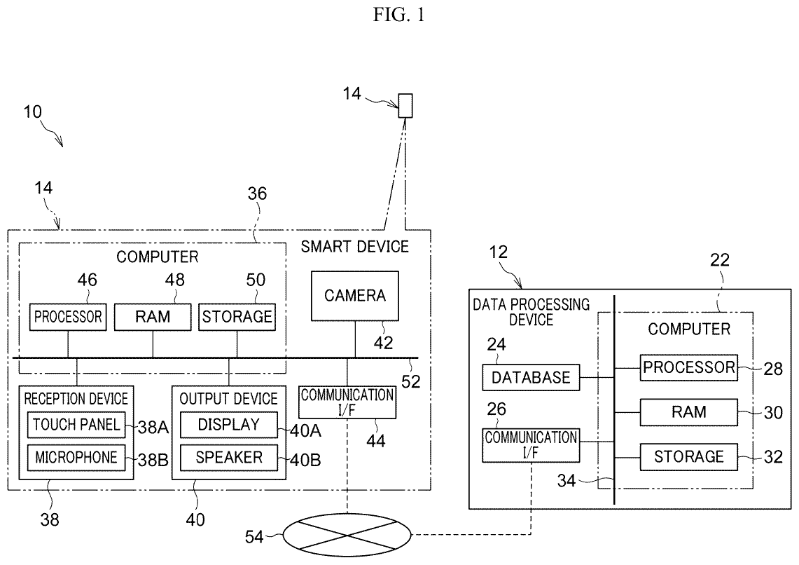

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

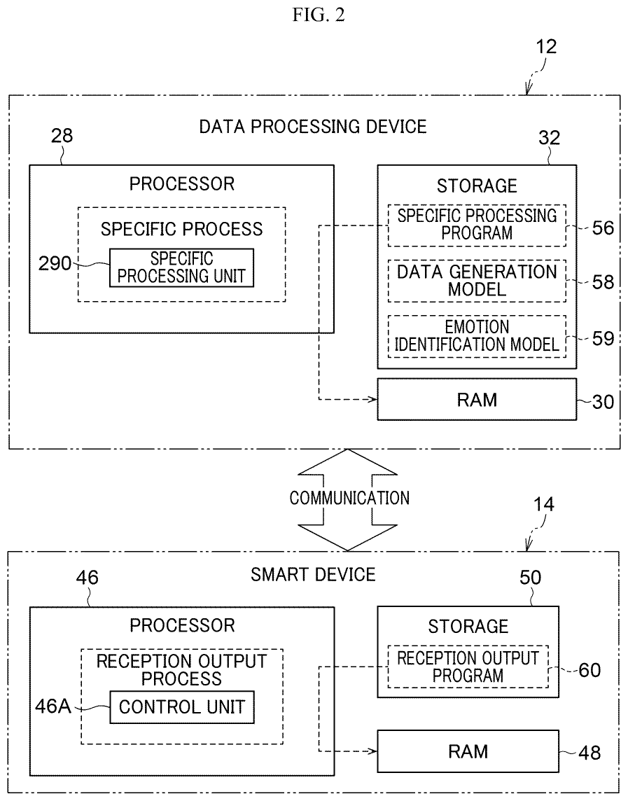

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems that generate promotional text based on content information typically require substantial manual data preparation and prompt design by human operators. In many environments, content-related information, such as creator data, work data, and descriptive data, is distributed across heterogeneous external data sources that expose different schemas, field names, and data structures. Processors in existing systems generally treat this heterogeneous data as unstructured text or as ad hoc fields, and do not provide an integrated, machine-optimized data pipeline that normalizes, indexes, and reuses such information for automated natural language generation. As a result, significant computing resources are wasted on repetitive parsing and formatting, and the effectiveness of generative AI models depends heavily on manual prompt engineering, leading to inconsistent quality and low scalability.

In addition, conventional systems often invoke a generative AI model with prompts that are constructed on a per-use, free-form basis, without systematic embedding of structured domain information stored in a relational data storage resource. The processor typically does not maintain an explicit correspondence among prompt sentences, underlying structured information, and generated promotional text output. Consequently, the computer cannot automatically adapt generation conditions based on observed performance, user edits, or evaluation indices, and must instead rely on manual tuning. This leads to inefficient utilization of processing resources, suboptimal use of storage structures and indexes, and limited improvement in generation quality over time.

Furthermore, in many known approaches, the role of the processor is limited to acting as a pass-through between a user interface and a generative AI model. The processor does not reconfigure its internal data pipelines, retrieval logic, or prompt construction mechanisms based on feedback about generated outputs. This lack of feedback-driven adaptation prevents the computing system from operating as an optimized, closed-loop architecture that improves the efficiency and reliability of promotional text generation as more interactions occur. Accordingly, there is a need for a computer-implemented technique that improves the functioning of the processor itself by: (i) unifying heterogeneous content-related data into a normalized internal format suitable for automated retrieval, (ii) automatically constructing template-based prompt sentences that systematically embed structured information, and (iii) updating generation conditions based on recorded correspondences and evaluation metrics so as to enhance text quality and operational efficiency in subsequent operations.

The specific processing by the specific processing unit 290 of the data processing device 12 in Example 1 is realized by the following means.

The present invention provides a server comprising a processor configured to communicate, via one or more communication interfaces, with a plurality of external information sources to acquire music-related information, to store acquired structured data in a temporary storage resource, to analyze music-related information stored in the temporary storage resource by using a general-purpose information processing program, to normalize data item names and data structures that differ among the information sources into a unified internal data format by data-conversion processing resources, to perform organization of the music-related information by complementing missing values and removing duplicate records, to store the normalized music-related information in a relational data storage resource while assigning identification information and index information such that the music-related information is accumulated in a form suitable for subsequent retrieval, to retrieve desired music-related information from the relational data storage resource in response to a user operation and to extract information for constructing a prompt sentence candidate as a generation-support instruction sentence based on a retrieval result, to automatically generate a prompt sentence to be input to a generative AI model by combining the extracted information with condition information input by a user, to construct the prompt sentence in a template format in which contents of the music-related information accumulated in the relational data storage resource, including information items belonging to higher-level concepts of performer information, work information, and promotional description information, are automatically embedded, to input the prompt sentence and corresponding music-related information to the generative AI model and cause the generative AI model to automatically generate promotional text data by natural language generation processing, and to record a correspondence among the prompt sentence, the music-related information, the automatically generated promotional text data, and at least one of a user editing operation result and an evaluation index, and to update at least one generation condition of the generative AI model or automatic prompt sentence generation processing based on the recorded correspondence. This enables the server-side processor to improve its own operation by automatically transforming heterogeneous external data into an optimized internal representation, systematically constructing template-based prompt sentences that efficiently utilize indexed structured information, and adaptively refining generation conditions in a closed-loop manner, thereby enhancing text quality, reducing manual intervention, and increasing the overall computational efficiency of promotional text generation.
The term “processor” refers to a hardware or virtual information processing unit, such as a central processing unit or an execution core in a computing environment, that executes instructions to perform communication, data processing, storage control, retrieval, and control of a generative AI model.
The term “information source” refers to an external computing system or service that provides digital data, including but not limited to servers, databases, and network services that supply music-related information via an interface such as an application programming interface.
The term “music-related information” refers to digital data items associated with musical content, including but not limited to creator information, work information, performance information, descriptive information, and other metadata used for promotion and management of musical works.
The term “structured data” refers to information organized according to a defined schema or format, such as key-value pairs, records, or tables, that allows deterministic parsing, indexing, and transformation by a computer program.
The term “temporary storage resource” refers to a volatile or non-volatile storage medium, such as a memory area or a file system region, used to hold acquired or intermediate data for a limited time during processing before the data is moved to long-term storage.
The term “general-purpose information processing program” refers to software executed by the processor to perform data analysis, transformation, and control operations, without being limited to a specific fixed function, and capable of handling various types of input data formats.
The term “data-conversion processing resources” refers to software and hardware resources used by the processor to transform data from one format or schema into another, including normalization, mapping, and reformatting of data item names and structures.
The term “unified internal data format” refers to an internal schema or representation defined within the system, in which heterogeneous data from multiple information sources is normalized so that data items can be consistently stored, retrieved, and processed by the processor.
The term “missing value complement” refers to a processing operation in which the processor detects absent or undefined data items in a data set and fills such items using predetermined rules, default values, or derived values.
The term “duplicate record removal” refers to a processing operation in which the processor identifies and eliminates multiple records representing the same underlying entity based on one or more matching criteria, thereby ensuring that only a single representative record is retained.
The term “relational data storage resource” refers to a data storage system that organizes and stores data in relational structures, such as tables with rows and columns, and supports relational operations including indexing, querying, and joining.
The term “identification information” refers to data used to uniquely distinguish a record or entity within the system, including but not limited to identifiers, keys, or codes assigned by the processor or derived from source data.
The term “index information” refers to auxiliary data structures constructed over stored data, such as indexes or lookup structures, that enable efficient search and retrieval based on one or more data items.
The term “retrieval” refers to a processing operation in which the processor executes search queries or access operations against stored data to obtain records that satisfy specified conditions or parameters.
The term “user operation” refers to one or more inputs provided by a human operator to the system, such as selecting items, specifying conditions, or triggering generation, via an input device or user interface.
The term “prompt sentence candidate” refers to an intermediate instruction text, or draft of an instruction text, that is generated based on retrieved information and is used as a basis for constructing a final prompt sentence to be provided to a generative AI model.
The term “generation-support instruction sentence” refers to a textual instruction that guides a generative AI model in generating an output, and that specifies constraints such as content, style, length, or intended audience.
The term “condition information” refers to additional parameters or instructions input by a user, such as desired language, tone, length, or target platform, that influence the way the generative AI model generates text.
The term “prompt sentence” refers to a text-based instruction, possibly including embedded data, that is provided as input to a generative AI model in order to cause the model to generate corresponding output content.
The term “template format” refers to a predefined textual structure that includes fixed portions and insertion positions, into which variable information such as music-related information and condition information is automatically embedded to form a complete prompt sentence.
The term “generative AI model” refers to a machine-learned model, such as a neural network configured for generative tasks, that receives input data including a prompt sentence and produces output content, such as natural language text, by performing learned generation operations.
The term “natural language generation processing” refers to a sequence of computational operations performed by the generative AI model to output human-readable text in one or more natural languages based on input data, including the prompt sentence and structured information.
The term “promotional text data” refers to generated natural language content that is intended to promote or advertise subjects such as musical works, creators, or related services, and that is suitable for use in communication or advertising channels.
The term “user display resource” refers to a presentation device or interface, such as a display screen, graphical user interface, or web interface, through which generated content and other information are visually provided to a user.
The term “operation resource” refers to an input mechanism or interface, such as a keyboard, pointing device, touch interface, or interaction component, that allows the user to edit, approve, store, or otherwise control data within the system.
The term “performer information” refers to music-related information describing a creator, artist, or performer of a work, including but not limited to names, groups, roles, and background attributes.
The term “work information” refers to music-related information describing a musical work or content item, including but not limited to titles, versions, release dates, genres, and associated identifiers.
The term “promotional description information” refers to textual or structured information that explains, highlights, or markets a work or performer, including summaries, feature descriptions, and suggested use cases.
The term “advertising communication” refers to a form of electronic or digital communication in which promotional text data is transmitted to recipients via channels such as messaging systems, social platforms, or email for the purpose of promotion.
The term “advertisement display” refers to a presentation of promotional text data and optionally related media on a display medium, such as a web page, application interface, or digital signage, for advertising purposes.
The term “generation condition” refers to a parameter, rule, or configuration that affects how the generative AI model or prompt sentence generation processing operates, including but not limited to model parameters, decoding parameters, template selection, or content constraints.
The term “evaluation index” refers to a metric or indicator used to assess the quality, effectiveness, or performance of generated promotional text data, including but not limited to user satisfaction scores, engagement metrics, or automatically computed text quality measures.
The term “correspondence” refers to an association or mapping stored by the system that links together a prompt sentence, related music-related information, generated promotional text data, and at least one of a user editing operation result or an evaluation index.

In one embodiment, a server executes a computer program that implements the claimed system on a general-purpose computing platform. The server includes at least one central processing unit, a main memory, a non-volatile storage device, and a network interface. The server executes an operating system such as a general-purpose server operating system and executes application software written, for example, in a high-level programming language. The server uses an HTTP client library, a data analysis library, an object-relational mapping library, and a relational database management system. In one concrete configuration, the server uses an HTTP client library corresponding to a general “requests” library, a data analysis library corresponding to a general “pandas” library, an object-relational mapping library such as a general “SQLAlchemy” library, and a relational database such as a general SQL-type database.

The server generates and stores a program that implements a data acquisition module, a normalization module, a storage control module, a retrieval module, a prompt construction module, a generative AI interface module, and a feedback learning module. The server stores these modules in the non-volatile storage device and loads them into main memory for execution by the processor. The server configures a relational database schema including tables that store normalized music-related information and tables that store generated prompt sentences, generated promotional text, and associated evaluation information.

The server uses the HTTP client library to communicate with a plurality of external information sources, such as content distribution services and information aggregation services, through application programming interfaces. The server receives structured responses, typically in a hierarchical text format, and stores the raw responses in a temporary storage area in the storage device. The server timestamps each stored response and associates the response with a source identifier and a retrieval context. The server thereby creates a deterministic record of source data that can be reprocessed and audited.

The server applies the data analysis library to parse and normalize the acquired data. The server converts hierarchical structures into tabular records with explicit columns representing higher-level concepts such as performer information, work information, and promotional description information. The server maps heterogeneous field names from different information sources to a unified internal schema by using a rule set stored in a configuration table. For example, the server maps “artist,” “creator_name,” and “performer” to a canonical “performer_name” field, and maps “track_title,” “song_title,” and “work_name” to a canonical “work_title” field. The server uses deterministic mapping rules rather than free-form string processing, thereby reducing ambiguity and improving reproducibility.

The server performs missing value complement and duplicate record removal based on algorithmic criteria. The server applies validation rules defined in a schema definition, for example, that performer names must be non-empty and that work titles must satisfy a length and character-type constraint. When the server detects missing or invalid fields, the server derives replacement values from other fields or from related records, or marks the record as incomplete and excludes it from downstream prompt construction. The server identifies duplicates by computing hash values over key fields such as performer name and work title and by maintaining an index of these hash values in memory. The server discards records that share key fields and are older than existing records based on a temporal field. This processing reduces redundant data and improves retrieval speed, because the database does not have to process multiple inconsistent versions of the same work.

The server writes normalized records to the relational database via the object-relational mapping library. The server configures primary keys, foreign keys, and secondary indexes over fields such as performer name, work title, release date, and genre. The server thereby enables efficient search operations spanning multiple tables, for example, joining performer information and work information. By moving from unstructured or loosely structured external data to an indexed relational representation, the server reduces the computational cost of later queries and ensures that prompt construction can operate on a stable, well-defined set of attributes.

The terminal operates as a client device that interacts with the server over a network. The terminal may be implemented as a smartphone, a tablet, or a personal computer, and executes a client application or web browser. The terminal displays search interfaces and prompt configuration interfaces on a graphical user interface. The user operates the terminal to specify filters, such as selecting a particular performer, selecting works released within a date range, or specifying a target medium for promotion. The terminal transmits these filters to the server through a request message.

The server receives the request and queries the relational database using the specified conditions. The server returns a list of candidates, each containing normalized performer information, work information, and promotional description information. The terminal displays these candidates and allows the user to select one or more items for promotional text generation. The user may select, for example, a work with the normalized attributes:
Performer name: Example Performer
Work title: Example Track
Promotional description: “An electronic track featuring nostalgic synthesized sounds suitable for late-night listening.”

The server uses the prompt construction module to generate a prompt sentence in a template format. The server assembles the normalized fields into fixed slots in a textual template, for example:
“Performer: [performer_name]
Work: [work_title]
Description: [promotional_description]
Task: [user_condition]”

The user enters condition information on the terminal, which may specify target language, tone, length, and use case. For example, the user may input the following prompt sentence condition:
“Write a 150-word introduction in English for a music blog, highlighting the nostalgic synthesized sound and the late-night listening atmosphere of this work.”

The server combines the normalized music-related information and the user condition to form a complete prompt sentence, such as:
“Performer: Example Performer
Work: Example Track
Description: An electronic track featuring nostalgic synthesized sounds suitable for late-night listening.
Task: Write a 150-word introduction in English for a music blog, highlighting the nostalgic synthesized sound and the late-night listening atmosphere of this work.”

The server then passes this prompt sentence, together with associated structured attributes, to the generative AI model via the generative AI interface module.

In one embodiment, the generative AI model is implemented as a transformer-based neural network architecture. The server deploys the model on a dedicated inference device, such as a graphics processing unit or an AI accelerator, and exposes an inference API. The model includes an embedding layer that converts input tokens (words, subwords, or characters) into dense vectors, multiple stacked attention layers that compute self-attention over token positions, feedforward layers that transform intermediate representations, and an output layer that maps hidden vectors back to token probability distributions. The server configures the model with parameters, such as a vocabulary size, an embedding dimension, a number of attention heads, and a number of layers, to support high-capacity text generation.

The server trains or fine-tunes the generative AI model on a training dataset that includes pairs of structured music-related information and desired promotional text outputs. The server uses supervised learning with a loss function such as cross-entropy between the predicted token distribution and the ground-truth tokens. The server applies gradient-based optimization methods, such as stochastic gradient descent with adaptive learning rates, to update model weights. During training, the server applies regularization methods, such as dropout and weight decay, and may apply data augmentation by varying prompts and paraphrasing promotional descriptions. The server saves the trained model parameters to the storage device and loads them for inference.

The server executes the generative AI model at inference time by tokenizing the prompt sentence, computing embeddings, and performing forward passes through the attention and feedforward layers to compute output token probabilities. The server uses decoding algorithms, such as greedy decoding, beam search, or top-k/top-p sampling, under control of parameters representing generation conditions, including temperature, maximum token length, and repetition penalties. These parameters are part of the generation conditions that the server later updates based on feedback. In contrast to a human author, the model applies high-dimensional vector operations and attention mechanisms to consider long-range dependencies in the prompt, which cannot be manually replicated at scale.

The server records the prompt sentence, the structured music-related information used to generate it, the generated promotional text data, and associated evaluation information in the relational database. The terminal displays the generated text to the user on the screen, enabling immediate review. The user may edit the text, for example by changing wording or adjusting length, and may approve or reject the generated output. The terminal transmits the editing operations and an explicit evaluation, such as a rating or a classification of usefulness, to the server. The server associates this feedback with the corresponding prompt and generated text.

The server uses the feedback learning module to update generation conditions. In one embodiment, the server computes statistics over past generations, such as average evaluation scores per decoder configuration, and selects parameter ranges that historically produced higher-quality outputs. The server may adjust temperature, sampling strategies, or template selection rules to favor configurations that yielded high user satisfaction. In another embodiment, the server builds a secondary model that predicts appropriate generation conditions based on features of the structured music-related information and user-specified conditions. The server then uses this secondary model to select generation conditions for future requests, thereby improving quality and consistency without requiring manual tuning.

The server can also fine-tune the generative AI model itself by using a subset of generated outputs and user feedback as training data. The server defines a loss function that combines cross-entropy with penalty terms based on user evaluations. The server updates model weights to reduce the loss, thereby biasing the model toward text characteristics that received positive evaluations. By incorporating feedback into the training process, the server enables the model to internalize domain-specific promotional styles and constraints.

The server's normalization and indexing of music-related information provide a technical improvement in data management. Because the server stores normalized attributes in relational tables with appropriate indexes, subsequent queries and joins are executed with reduced disk I/O and CPU usage compared to querying heterogeneous, unindexed raw data. The deterministic mapping and validation rules prevent malformed or inconsistent data from entering the generation pipeline, which reduces error rates in generated text and decreases the need for human correction. The server thus improves the reliability and efficiency of upstream data preparation.

The server's template-based prompt construction improves the internal functioning of the computing system by standardizing how structured information is embedded into prompt sentences. By enforcing a fixed prompt structure, the server reduces variability that would otherwise force the generative AI model to handle many incompatible input formats. This structured prompting leads to more stable attention patterns inside the transformer layers and lower variance in output quality. As a result, the generative AI model can generate promotional text with higher accuracy and reduced token-perplexity relative to ad hoc prompts.

The server's feedback-based control loop provides an additional technical benefit. Rather than merely executing a single, static generation path, the server continuously measures outcomes and reconfigures generation conditions and, in some embodiments, the model parameters. The server thus reduces computational waste by avoiding ineffective configurations and converges toward more efficient use of hardware resources. For example, by learning that certain decoding parameters tend to produce acceptable text with fewer tokens, the server can reduce average output length and inference time, lowering compute load and network usage for transmitting responses to terminals.

The terminal and server together implement an integrated architecture that goes beyond simple automation of human writing tasks. The server performs non-conventional internal operations, including schema-based normalization, hash-based deduplication, relational indexing, template-driven prompt creation, and feedback-guided adjustment of model and decoding parameters. These operations transform the computer into a specialized machine for managing and exploiting structured promotional data with improved speed, accuracy, and resource utilization. The system thereby enhances computer technology itself—specifically, data management and natural language generation pipelines—rather than merely implementing a business method on a generic computer.

The user interacts with the system by operating the terminal to select normalized data and specify high-level generation requirements, while the server determines the internal data transformations, storage structures, and model configurations. The user can, for example, input a condition such as:
“Create an English social media post introducing this work in a friendly tone for young listeners.”

The server then embeds this condition together with structured attributes into the template to produce a fully specified prompt sentence and routes it through the optimized generative pipeline. Because the system has normalized and indexed the underlying data and adjusted its generation parameters based on historical feedback, the server can generate an output post more quickly and with higher consistency than a conventional system that performs only ad hoc data retrieval and naive prompting.

In alternative embodiments, the server may run the generative AI model locally, on-premises, or as a distributed model across multiple devices. The server may also use different neural network architectures, such as encoder-decoder architectures or recurrent neural networks, as long as the model supports generative text output conditioned on input prompt sentences. The server may vary the internal schema of the relational database or the specific indexing strategies, provided that normalized music-related information is stored in a manner that enables efficient retrieval for prompt construction. The server may additionally support multiple languages and media types, and may adapt the template structures and learning rules accordingly.

Across these embodiments, the server consistently performs technical operations that improve the manner in which data is acquired, normalized, stored, retrieved, and processed for generative text output. The use of structured templates and feedback-driven parameter updates provides a non-conventional, computer-centric improvement in processing speed, generation quality, and computational efficiency, thereby enabling the claimed system to realize technical effects beyond mere automation of human promotional writing.

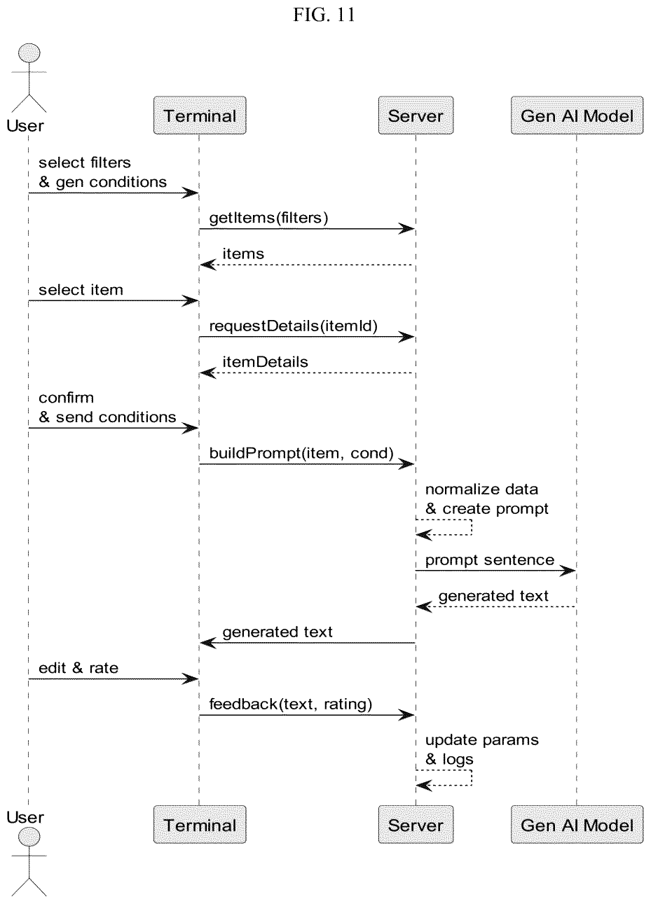

The following describes the processing flow using FIG. 11.

### Step 1:

The server acquires music-related information from external information sources.

The server receives as input a set of API endpoint definitions, authentication credentials, and scheduling parameters stored in a configuration file or database. The server uses an HTTP client library to send HTTP requests to each external information source, including necessary headers and query parameters. The server receives structured responses, typically in a hierarchical text format containing performer names, work titles, release dates, genres, and promotional descriptions. The server writes the raw response bodies, together with timestamps and source identifiers, to a temporary storage area in a file system or non-volatile storage. As output, the server produces a collection of timestamped raw data files or records that are ready for normalization.

### Step 2:

The server parses and flattens the acquired music-related information into intermediate tabular data.

The server receives as input the raw data files or records created in Step 1. The server loads each file into memory and parses the hierarchical structure into native data objects. The server then iterates through arrays of items and extracts relevant fields such as “artist,” “title,” “description,” and “release_date.” The server converts these items into rows of an intermediate table-like structure, for example a list of dictionaries or an in-memory table, assigning each field to a fixed column. The server includes additional columns for source identifiers and retrieval timestamps. As output, the server produces an intermediate set of tabular records that represent the original heterogeneous data in a flat, row-based format.

### Step 3:

The server normalizes field names and data formats into a unified internal schema.

The server receives as input the intermediate tabular records from Step 2 and a configuration describing mappings from external field names to internal canonical field names. The server applies these mappings to each record, replacing source-specific names such as “artist_name,” “performer,” or “creator” with a canonical field such as “performer_name,” and replacing “track_title,” “song,” or “work_name” with “work_title.” The server also converts data formats for fields such as dates and enumerated types to a single standardized representation. The server performs these conversions by calling format-conversion routines and validation functions. As output, the server generates a set of normalized records that conform to a unified internal schema.

### Step 4:

The server performs data quality checks, missing value complement, and duplicate record removal.

The server receives as input the normalized records from Step 3 and a set of validation rules and duplicate detection criteria. The server validates each record by checking that required fields such as performer_name and work_title are present and that values satisfy length and character-type constraints. When the server detects missing values, the server attempts to fill them using defined rules, such as copying values from related records, inferring defaults from genres, or applying static default values. The server computes hash values or composite keys over selected fields to detect duplicates and compares timestamps or version numbers to determine which record is the most recent. The server discards or flags outdated or redundant records and logs invalid records for later inspection. As output, the server produces a cleaned set of records that are validated, with missing values complemented where possible, and duplicates removed.

### Step 5:

The server stores cleaned music-related information in a relational database with indexes.

The server receives as input the cleaned records from Step 4 and a database schema definition describing tables, primary keys, and index fields. The server opens a connection to the relational database and constructs insert or update operations for each record, mapping internal fields such as performer_name, work_title, release_date, genre, and promotional_description to table columns. The server checks for existing rows with matching keys and either inserts new rows or updates existing ones. The server ensures that indexes over key columns such as performer_name and work_title are maintained. As output, the server produces a relational database state in which normalized music-related information is stored and indexed for efficient retrieval.

### Step 6:

The terminal acquires candidate items for promotion based on user-specified filters.

The terminal receives as input user operations specifying filters, such as selecting a particular performer, genre, release period, or popularity threshold, via a graphical user interface. The terminal constructs a retrieval request message containing these filters and sends it to the server through a network. The server receives the filters, translates them into database queries, and executes the queries against the relational database. The server returns a list of candidate items with normalized attributes. The terminal receives the list as a response message and renders it on the display as selectable entries. As output, the terminal presents to the user a set of candidate performers and works that match the specified conditions.

### Step 7:

The user selects target music-related information for promotional text generation.

The user receives as input the list of candidate items displayed by the terminal. The user inspects the displayed attributes such as performer_name, work_title, release_date, and promotional_description. The user then performs a selection operation, for example tapping or clicking on one or more items that should be used for generating promotional text. The terminal records the identifiers of the selected items and may send a detail request to the server to obtain additional fields, such as extended promotional descriptions or related works. The terminal receives detailed information from the server and stores it in local memory. As output, the terminal holds a set of fully specified music-related records selected by the user for subsequent prompt construction.

### Step 8:

The user specifies generation conditions for the promotional text.

The user receives as input the detailed information about the selected items shown on the terminal. The user decides on generation goals, such as target language, tone, text length, and intended publication medium. The user enters these conditions into text fields or selects them from options on the terminal interface. For example, the user may type: “Write a 150-word introduction in English for a music blog, highlighting the nostalgic synthesized sound and the late-night listening atmosphere of this work.” The terminal records the entered condition information as a text string or structured set of parameters. As output, the terminal provides to the server a representation of the user-specified generation conditions.

### Step 9:

The server constructs a template-based prompt sentence combining structured data and generation conditions.

The server receives as input the selected music-related records from Step 7 and the generation conditions from Step 8. The server loads a prompt template, which defines fixed text segments and insertion positions for structured fields. The server replaces placeholders in the template, such as [performer_name], [work_title], and [promotional_description], with corresponding values from the selected records. The server appends or embeds the user's condition text into a designated “Task” section. Using the example, the server generates a prompt sentence such as:
“Performer: Example Performer
Work: Example Track
Description: An electronic track featuring nostalgic synthesized sounds suitable for late-night listening.
Task: Write a 150-word introduction in English for a music blog, highlighting the nostalgic synthesized sound and the late-night listening atmosphere of this work.”

The server concatenates these parts into a single text string. As output, the server produces a fully constructed prompt sentence ready for input to the generative AI model.

### Step 10:

The server encodes the prompt sentence and executes inference on the generative AI model.

The server receives as input the constructed prompt sentence from Step 9 and a set of generation parameters such as maximum token length, temperature, and decoding strategy. The server tokenizes the prompt sentence into tokens according to the vocabulary of the generative AI model and converts tokens into numeric identifiers. The server feeds the sequence of token identifiers into the generative AI model, which is implemented as a transformer-based neural network residing on an inference device. The server computes forward passes through the embedding layer, multiple attention layers, and feedforward layers, obtaining at each decoding step a probability distribution over possible next tokens. The server applies a decoding algorithm, such as beam search or top-k sampling, controlled by the generation parameters, to select the next token. The server iteratively appends selected tokens to the output sequence until a termination condition is met. As output, the server obtains a sequence of token identifiers that represent the generated promotional text.

### Step 11:

The server decodes the generated tokens into natural language promotional text and logs the generation.

The server receives as input the sequence of token identifiers produced by the generative AI model in Step 10. The server converts token identifiers back into text units using the model's vocabulary mapping, concatenates the text units into a coherent string, and performs post-processing such as trimming whitespace and normalizing punctuation. The server then stores the prompt sentence, the underlying structured music-related information, the generated promotional text, and the used generation parameters in the relational database. The server includes timestamps and references to the user and terminal that initiated the generation. As output, the server produces a finalized promotional text string and a persistent record of the entire generation context.

### Step 12:

The terminal displays the generated promotional text and captures user feedback.

The terminal receives as input the generated promotional text and associated identifiers from the server. The terminal renders the text in an editable area on the display and may show metadata such as the performer_name and work_title above the text. The user reads the generated text, optionally edits the content by inserting, deleting, or modifying sentences, and may assign an evaluation, such as a rating or a binary acceptance flag. The terminal records the edited text and evaluation data. The user then issues a save or submit command. The terminal sends the edited text and evaluation data back to the server. As output, the terminal provides the server with user feedback linked to the specific generated text.

### Step 13:

The server updates generation conditions based on recorded correspondences and user feedback.

The server receives as input the edited promotional text, user evaluation information, and references to the original prompt sentence and structured data. The server compares the generated text and the edited text to calculate differences, such as added or removed phrases, and derives quality indicators. The server aggregates feedback across many generations to compute statistics that relate specific generation parameters and prompt template configurations to observed quality metrics. The server updates stored parameter profiles, for example by adjusting default temperature values, preferred decoding strategies, or template variants for certain types of works. In some configurations, the server fine-tunes the generative AI model by adding high-rated pairs of prompts and user-validated outputs to a training dataset and performing additional training steps. As output, the server produces updated generation settings and, optionally, updated model parameters that will be used in future executions of Step 10.

### Step 14:

The server and terminal reuse improved generation settings for subsequent promotional text generation.

The server receives as input a new request from the terminal initiated by the user for another work or performer. The server retrieves the latest generation settings, such as optimized decoding parameters and selected prompt templates, from the database. The terminal again collects user conditions, and the server constructs a new prompt sentence using the improved template and parameters. The server then executes the generation pipeline as in previous steps but under updated conditions, which have been statistically determined to yield higher-quality or more efficient promotional texts. As output, the server and terminal deliver promotional text that benefits from accumulated feedback, with improved consistency, reduced need for manual editing, and more efficient use of computational resources.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content distribution systems that deliver information regarding new media releases typically rely on static rule-based filtering and pre-authored promotional messages. Such systems suffer from several technical drawbacks. First, the systems generally process heterogeneous structured data from multiple information sources in an ad hoc manner, which leads to redundant storage, inefficient querying, and inconsistent data formats, thereby increasing processing time and resource consumption in the server. Second, the systems are not configured to tightly integrate user preference information and user behavioral history information into the end-to-end pipeline of data normalization, filtering, and text generation. As a result, the systems often deliver notifications that are poorly tailored to individual users, causing unnecessary network traffic and excessive client-side processing, while failing to improve user engagement metrics.

Furthermore, existing systems that incorporate generative AI models typically use fixed, manually designed prompt sentences that are not dynamically adapted based on measurable performance indicators, such as opening status, click status, reproduction status, or explicit evaluation feedback from users. This lack of feedback-driven prompt control and model-parameter adjustment results in suboptimal utilization of computational resources associated with the generative AI model and prevents continuous improvement of the generated promotional or recommendation texts. In addition, known systems often treat the generative AI model as a stand-alone text generator, without integrating it with real-time notification mechanisms and structured meeting-material generation, thereby requiring separate workflows and duplicative processing for user-facing notifications and internal decision-making documents.

Accordingly, there is a need for a technical solution that (i) efficiently acquires heterogeneous structured data including new release information from multiple information sources, (ii) normalizes and stores the data in an internal format suitable for high-performance filtering, (iii) integrates user preference information and behavioral history information into the filtering and text-generation stages, (iv) automatically constructs and updates prompt sentences for a generative AI model based on evaluation indices, and (v) generates both real-time notification information for terminal devices and structured meeting-material data, all within a unified processing architecture. Such a solution should improve the operation of the server itself by reducing redundant processing, improving the relevance and effectiveness of notifications, and enabling adaptive optimization of the generative AI pipeline based on measured system performance metrics.

The specific processing by the specific processing unit 290 of the data processing device 12 in Application Example 1 is realized by the following means.

The present invention provides a server comprising a processor and a terminal interface, the processor being configured to acquire, via a communication network, structured data including new release information from a plurality of information sources; to parse the structured data and normalize item names and value formats to generate an internal-format data set stored in a storage device; to perform filtering processing on the internal-format data set based on preference information and behavioral history information of a user to select new release information; to construct a prompt sentence, based on an information set including the selected new release information and the preference information, for instructing a generative AI model to generate a promotion text or a recommendation text; to input the prompt sentence and the information set into the generative AI model and obtain output data including the promotion text or the recommendation text; to generate notification information based on the output data and the selected new release information and to transmit, in real time, the notification information to a terminal device; to receive operation information from the terminal device indicating a reproduction instruction operation or an evaluation operation performed by the user; to update the preference information based on the operation information; and to control subsequent filtering processing and subsequent construction of the prompt sentence based on the updated preference information, and further being configured to control the prompt sentence and operation parameters of the generative AI model based on evaluation indices derived from at least one of opening status information, click status information, reproduction status information, and the evaluation operation, and to generate meeting-material data by applying material data including the new release information to a document-generation template. This enables an integrated and technically improved information processing pipeline in which heterogeneous new release data is normalized and efficiently filtered, user-tailored promotional or recommendation texts are dynamically generated and optimized through feedback-driven control of a generative AI model, real-time notifications are delivered to terminal devices with reduced unnecessary traffic and improved relevance, and consistent internal meeting materials are produced from the same underlying data, thereby enhancing the overall efficiency, adaptability, and performance of the server-based content distribution system.
The term “processor” refers to a hardware-based or virtualized information processing unit, including one or more central processing units, graphics processing units, or other computation cores, that executes instructions to perform data acquisition, data processing, communication control, and control of a generative AI model within the system.
The term “terminal device” refers to an information processing apparatus operated by a user, including but not limited to a mobile terminal, a wearable terminal, or a general-purpose computing device, that is configured to receive notification information from the processor, present the notification information on a display, accept user operations, and transmit operation information to the processor.
The term “communication network” refers to a wired or wireless data communication infrastructure, including wide area networks, local area networks, or mobile communication networks, that enables data exchange between the processor, information sources, and terminal devices.
The term “structured data” refers to data that is organized according to a predetermined schema or format, such as key-value pairs, tables, or hierarchical objects, and that includes fields representing attributes of new release information.
The term “new release information” refers to information indicating the availability or publication of new content items, including at least identifiers, titles, creators, classification attributes, release dates, and optional promotional descriptions of the content items.
The term “information source” refers to a server, service, or data provider that supplies structured data including new release information to the processor via the communication network, for example through an application programming interface or other data access mechanism.
The term “storage device” refers to a non-transitory computer-readable medium, including main memory, auxiliary storage, or network-accessible storage, that stores structured data, internal-format data sets, user-related information, and generated texts for use by the processor.
The term “internal-format data set” refers to a collection of data records derived from heterogeneous structured data, in which item names, value formats, and data types are normalized according to a unified schema so as to facilitate efficient retrieval, filtering, and further processing by the processor.
The term “preference information” refers to data representing one or more user-specific conditions, such as preferred categories, creators, or attributes of content, that the processor uses as criteria for selecting new release information and for constructing prompt sentences.
The term “behavioral history information” refers to data representing past user actions related to content or notifications, including at least viewing, selection, reproduction, or interaction events, that the processor uses to refine preference information and to adjust subsequent processing.
The term “filtering processing” refers to a computational operation performed by the processor that selects a subset of records from the internal-format data set by applying conditions based on at least preference information, behavioral history information, or attributes of new release information.
The term “information set” refers to a collection of data elements, including at least selected new release information and preference information, that is used as contextual input when constructing a prompt sentence and interacting with the generative AI model.
The term “prompt sentence” refers to a sequence of characters or tokens, possibly including embedded structured data, that specifies instructions, constraints, or context to a generative AI model so as to control generation of a promotion text or a recommendation text.
The term “generative AI model” refers to a machine-learned computational model capable of generating natural-language output in response to input data and a prompt sentence, including but not limited to neural network-based language models.
The term “promotion text” refers to natural-language content generated by the generative AI model, intended to describe or advertise one or more content items in a manner suitable for electronic promotional communication or advertising display.
The term “recommendation text” refers to natural-language content generated by the generative AI model, intended to suggest one or more content items to a user based on the user's preference information and behavioral history information.
The term “output data” refers to data returned by the generative AI model in response to a prompt sentence and an information set, the data including at least a promotion text or a recommendation text and optionally metadata associated with the generated text.
The term “notification information” refers to a data structure generated by the processor that contains at least part of the selected new release information and at least one of a promotion text and a recommendation text, and that is formatted for presentation and delivery to a terminal device.
The term “operation information” refers to data transmitted from a terminal device to the processor, indicating that a user has performed an operation on notification information, including at least a reproduction instruction operation or an evaluation operation.
The term “reproduction instruction operation” refers to a user operation indicating a request to access or play a content item associated with notification information, such as activation of a playback control, selection of a content item, or invocation of an external content service.
The term “evaluation operation” refers to a user operation indicating qualitative or quantitative feedback regarding content or notification information, including but not limited to a rating, a like or dislike input, or a relevance indication.
The term “opening status information” refers to data indicating whether and how a user has opened or viewed a notification, including timestamps, frequency, or duration related to opening events.
The term “click status information” refers to data indicating whether and how a user has selected or activated an interactive element within notification information, including counts, targets, and timestamps of click events.
The term “reproduction status information” refers to data indicating whether and how a user has caused content to be reproduced as a result of notification information, including whether playback was started, duration of playback, or completion status.
The term “evaluation indices” refers to numerical or categorical metrics derived from at least one of opening status information, click status information, reproduction status information, and evaluation operations, which the processor uses to assess performance of generated texts and to control subsequent processing.
The term “operation parameters of the generative AI model” refers to adjustable settings or control values that influence the behavior of the generative AI model, including but not limited to temperature, output length, style constraints, or model selection parameters.
The term “document-generation template” refers to a predefined structural and formatting specification for a document, including placeholders for data fields and text segments, which the processor uses to generate meeting-material data by inserting material data.
The term “meeting-material data” refers to document data generated by the processor based on material data including new release information and, optionally, generated texts, the document data being structured for use in internal decision-making, discussion, or planning sessions.
The term “material data” refers to data that is used as a source for generating meeting-material data, including at least normalized new release information, classification information, and optionally promotion texts or recommendation texts.

In one embodiment, a server executes a program on a hardware platform including one or more general-purpose processors, a main memory, a non-volatile storage device, and a network interface. The server uses a server-operating system, a runtime environment, and an application framework to implement the claimed functions. The server includes a communication module, a data normalization module, a preference management module, a filtering module, a generative AI interaction module, a notification generation module, an evaluation analysis module, and a document generation module. The server communicates with at least one terminal, and each terminal includes a processor, a memory, a display, an input unit, and a communication interface.

The server uses a network interface conforming to a packet-based communication protocol to acquire structured data including new release information from multiple information sources. The server receives the structured data as machine-readable objects, for example, as hierarchically organized key-value pairs. The server stores the received data in a storage device implementing a persistent data store. The server manages the stored data in a tabular data structure with fields including at least an identifier field, a creator field, a title field, a category field, a release date field, and a promotion description field. The server allocates indexes to selected fields such as the release date field and the category field to enable high-speed retrieval operations.

The server executes the data normalization module to convert heterogeneous field names and value formats from different information sources into a unified internal data schema. The server maps multiple source-specific identifiers to a single internal identifier field and converts multiple time formats to a normalized timestamp type. The server performs these conversions by applying deterministic mapping rules and type conversion rules stored in a configuration repository. The server resolves duplicate records by computing a similarity score between candidate records based on a combination of normalized creator, title, and release date attributes and discards or merges records whose similarity score exceeds a predetermined threshold. By performing this normalization and deduplication, the server reduces storage redundancy, improves query performance for subsequent filtering, and decreases computational load in the generative AI interaction module.

The server executes the preference management module to store and update preference information and behavioral history information for each user. The server defines a preference vector structure that includes weighted dimensions corresponding to content categories, creators, and contextual attributes. The server updates the preference vector by applying a weighted averaging algorithm when new behavioral history information is received from a terminal. For example, when the user selects or reproduces a particular category of content, the server increases a weight of the corresponding category dimension and decays weights of unrelated dimensions. The server maintains the preference vector in a compact numeric representation to enable efficient distance computations and ranking operations during filtering.

The terminal displays, on the display, graphical controls allowing the user to specify initial preferences such as categories and creators. The terminal converts the user's selections into a structured preference message and transmits the message to the server using the communication interface. The server receives the preference message and initializes the preference vector for the corresponding user. The server stores both the explicit preference information and the preference vector in the storage device, associating them with a user identifier.

The server executes the filtering module to select new release information relevant to each user from the internal-format data set. The server uses the preference vector and the normalized attribute vectors of content items to compute a similarity measure, for example, a cosine similarity or a weighted dot product, between each new release and the user's preference vector. The server combines this similarity measure with rule-based conditions, such as a minimum release date and required categories, to form a hybrid selection function. The server selects new release items whose combined score exceeds a predetermined threshold and orders the selected items by descending score. This hybrid selection algorithm provides a technical effect of reducing the number of candidate content items that are passed to the generative AI interaction module and the notification generation module, which reduces processing time and network load.

The server executes the generative AI interaction module to generate a promotion text or a recommendation text. The server uses a generative AI model implemented as a machine-learned sequence model based on a multi-layer neural network architecture. In one embodiment, the generative AI model is a transformer-based language model composed of an embedding layer, a plurality of self-attention layers, and a final output projection layer. The server represents textual input, including the prompt sentence and the content of selected new release items, as token sequences. The server uses an encoder to convert tokens into embedding vectors and applies multiple self-attention operations to compute context-aware representations. The server applies a softmax function at the output layer to obtain token probability distributions and generates a natural-language string by sequentially selecting tokens according to the distributions, with a temperature parameter and a maximum-length parameter that are managed by the server as operation parameters of the generative AI model.

The server constructs a prompt sentence to control the behavior of the generative AI model. The server combines template text with dynamically selected fields from the internal-format data set and the preference information. For example, the server constructs a prompt sentence such as:
“You are a recommendation assistant for a content distribution platform. Using the following new releases, write one concise notification text (no more than 200 characters) that will attract a user who prefers modern jazz. Focus on the creator names and the mood of the tracks. Output only the final sentence.”

The server embeds structured attributes, such as creator names, track titles, categories, and short descriptions, in the textual context following the instruction portion of the prompt sentence. The server adjusts the wording of the prompt sentence depending on evaluation indices, such as opening status, click status, and reproduction status, as described below. By generating such prompt sentences programmatically, the server changes the internal attention patterns and token selection behavior of the generative AI model in a way that is not achievable through static, manually designed prompts.

The server executes the evaluation analysis module to calculate evaluation indices based on behavior information received from terminals. The terminal presents notification information on the display and transmits operation information when the user opens a notification, clicks an interactive element, starts reproduction of content, or submits an evaluation. The server receives timestamped operation information and correlates it with identifiers of notification information and underlying generated texts. The server computes, for each generated text pattern or prompt configuration, quantitative metrics such as open rate, click-through rate, reproduction start rate, and evaluation score distribution. The server stores these metrics in a performance record associated with a prompt configuration identifier and generative AI operation parameters, such as temperature and maximum output length.

The server modifies the prompt sentence configuration and generative AI operation parameters based on the computed evaluation indices. In one embodiment, the server applies a multi-armed bandit algorithm or a gradient-based update rule to adjust continuous parameters such as temperature and length, and to select between discrete prompt templates. The server, for example, decreases the temperature value when high-variance outputs correlate with low engagement metrics and increases emphasis phrases in the prompt sentence when particular formulations show higher reproduction rates. In this way, the server implements an adaptive optimization loop in which the performance of the generative AI model, with respect to system-level metrics, is improved over time. This yields a technical improvement of the generative AI pipeline and reduces wasted computational cycles spent on low-performing text variations.

The server generates notification information using the notification generation module. The server constructs a compact data structure containing identifiers of selected new releases, relevant attributes extracted from the internal-format data set, and at least one generated promotion text or recommendation text. The server encodes the notification information in a format suitable for efficient transmission over the communication network. The server applies size constraints and compression strategies to reduce the amount of data sent to terminals. For example, the server omits attributes not used by the terminal display logic and encodes repeated attribute values using identifiers. As a result, the server reduces communication bandwidth usage, lowers latency in delivering notifications, and reduces power consumption on the terminals.

The terminal receives the notification information from the server. The terminal decodes the received data and presents the notification information on the display in a structured layout. The terminal displays a list of new release items with a title, creator, short description, and a control to start reproduction or provide evaluation feedback. When the user activates a reproduction control, the terminal initiates access to a content source by opening an application or invoking a playback function. When the user enters an evaluation, such as a rating or an interest indicator, the terminal encapsulates the evaluation in an operation information structure that includes a notification identifier, a content identifier, the evaluation value, and a timestamp. The terminal sends the operation information to the server via the communication interface.

The server updates the preference information based on the operation information. The server uses a rule set defining how different kinds of evaluation and reproduction behaviors should adjust the preference vector. For example, the server increases the weight of a category when the user repeatedly reproduces items in that category and decreases the weight when the user repeatedly indicates low interest. The server applies a decay factor to older behaviors when computing the updated preference vector. This automatic update mechanism allows the system to reflect long-term trends and recent changes in user interest at a fine-grained vector level, which improves the precision of subsequent filtering and generative AI prompting.

The server executes the document generation module to create meeting-material data. The server retrieves normalized new release information and, in some embodiments, associated promotion texts or recommendation texts, and applies the data to a document-generation template. The server structures the meeting-material data into sections such as category-based listings, priority-based listings, and creator-based summaries. The server, in some embodiments, uses the generative AI model with a dedicated prompt sentence such as:
“Create a short editorial summary for the following week's new releases for an internal programming meeting. Emphasize trends in the jazz and pop categories, and describe potential audience reactions in three bullet points.”

The server inserts the generated editorial summary into a designated section of the document template. By generating meeting-material data from the same internal-format data set used for notifications, the server avoids duplicate data acquisition and transformation steps, reduces inconsistency between external and internal views of the data, and improves overall data management quality.

The server achieves technical effects beyond mere automation of human tasks. The normalization and indexing of heterogeneous structured data reduce query complexity and improve cache locality, which produce faster response times for filtering and prompt construction. The preference vector representation and adaptive update scheme enable efficient similarity computation and dynamic personalization at scale, without exhaustive rule-based configuration. The generative AI model is integrated into a closed-loop optimization framework, in which prompt sentences and model parameters are adjusted based on measurable engagement metrics. This closed-loop configuration reduces the rate of low-relevance outputs and leads to more efficient use of computational resources, because the server spends fewer cycles generating and transmitting texts that users ignore. The compact notification structure and selective attribute transmission decrease network traffic volume and terminal power consumption. Taken together, these features improve the operation of the server and terminals as data processing machines.

The server uses specific model-training methods in embodiments where the generative AI model is trained or fine-tuned. The server constructs a training data set composed of input text sequences, including prompt-like contexts derived from new release metadata, and target text sequences representing effective promotion texts or recommendation texts. The server encodes the sequences as tokenized indices and feeds them to the transformer-based neural network. The server computes a loss value, such as a cross-entropy loss between predicted token distributions and target tokens, and updates network weights using a gradient descent method with a variant of stochastic gradient optimization. The server may perform data augmentation by reordering portions of metadata descriptions or injecting synthetic user preference descriptors to improve generalization. By tailoring the training procedure to the structure of new release information and preference-based contexts, the server achieves improved generation accuracy and robustness compared to generic language models, which contributes to the technical improvement in output quality and system efficiency.

The server can implement multiple variations of the above-described modules. In one alternative embodiment, the server uses a recurrent neural network, such as a multi-layer long short-term memory network, instead of a transformer architecture. In another embodiment, the server uses a mixture-of-experts architecture, where the processor routes different classes of prompt sentences to different sub-models optimized for short notifications, long-form documents, or editorial summaries. In yet another embodiment, the server employs a rule-based pre-filter before the generative AI model to exclude content items with low preference similarity scores, thereby further reducing the token length of prompt inputs and improving computational efficiency.

The server, the terminal, and the generative AI model cooperate according to the described configuration to implement a technically improved system. The server performs non-conventional combinations of data normalization, vector-based preference modeling, adaptive generative AI prompting, and feedback-driven model control that materially enhance the functioning of the computer system itself, in terms of processing speed, data management integrity, computational efficiency, and communication load reduction, rather than merely automating a human promotional workflow.

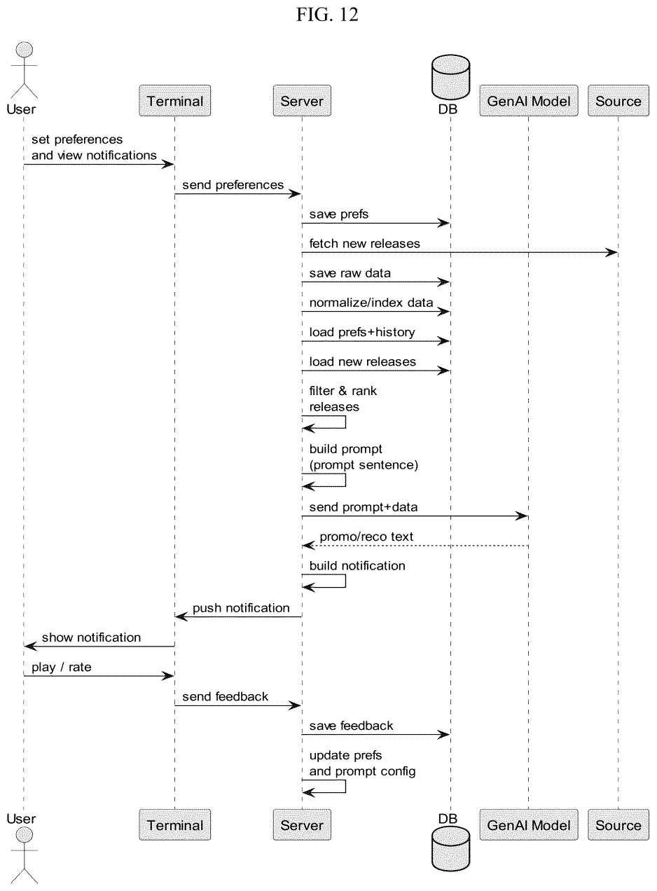

The following describes the processing flow using FIG. 12.

### Step 1:

The server acquires raw structured data including new release information from multiple information sources.

The server receives, as input, authentication information such as API keys, endpoint URLs, and request parameters including category conditions and release date ranges.

The server issues network requests to the information sources via a communication interface and obtains, as output, structured data records in a hierarchical format, each record including at least a creator name, a title, a category, a release date, and a promotion description.

The server stores the raw structured data in a temporary storage area for subsequent processing.

### Step 2:

The server normalizes the heterogeneous structured data into an internal-format data set.

The server takes, as input, the raw structured data obtained in Step 1.

The server performs data processing by mapping source-specific field names to unified internal field names, converting date strings to a normalized timestamp format, standardizing category labels, and trimming or encoding text fields.

The server outputs an internal-format data set in which each record has a fixed set of normalized fields such as internal_creator, internal_title, internal_category, internal_release_time, and internal_promotion_text, and stores this data set in a persistent storage device.

### Step 3:

The server performs deduplication and indexing on the internal-format data set.

The server receives, as input, the normalized records generated in Step 2.

The server computes similarity scores between records based on combinations of creator, title, and release time, and removes or merges records whose similarity scores exceed a predetermined threshold.

The server creates index structures for selected fields such as internal_release_time and internal_category to accelerate subsequent search and filtering operations, and outputs a deduplicated, indexed internal-format data set.

### Step 4:

The terminal acquires explicit preference information from the user and transmits it to the server.

The terminal receives, as input, user interactions on a graphical user interface, including selections of preferred categories, preferred creators, and notification options.

The terminal converts the user's selections into a structured preference message including a user identifier and selected preference attributes, and outputs the preference message by transmitting it to the server via a communication interface.

### Step 5:

The server initializes or updates preference information and a preference vector for the user.

The server receives, as input, the structured preference message from the terminal.

The server parses the preference message, maps selected categories and creators to vector dimensions, and computes or updates a numeric preference vector by assigning or adjusting weights for each dimension using a predetermined weighting algorithm.

The server stores, as output, the updated preference information and the preference vector in association with the user identifier in a storage device.

### Step 6:

The server updates behavioral history information based on operation information from the terminal.

The server takes, as input, operation information including notification identifiers, content identifiers, operation types such as open, click, reproduction, or evaluation, and timestamps.

The server appends the operation information to a behavioral history log and aggregates counts and durations per user and per content category.

The server outputs updated behavioral history information that reflects the user's recent and cumulative interactions with notifications and content.

Step 7:

The server refines the preference vector using behavioral history information.

The server receives, as input, the current preference vector and aggregated behavioral history information for a user.

The server performs data computation by adjusting weights in the preference vector according to rules that increase weights for frequently consumed or positively evaluated categories and decrease weights for rarely consumed or negatively evaluated categories, while applying a time-based decay factor to older behaviors.

The server outputs a refined preference vector that more accurately represents the user's current interests.

### Step 8:

The server selects relevant new release records using filtering and similarity computation.

The server takes, as input, the deduplicated, indexed internal-format data set and the refined preference vector for a user.

The server computes similarity scores between the preference vector and attribute vectors derived from each new release record, applies rule-based conditions such as a minimum release time and required categories, and combines these values into a selection score.

The server outputs a ranked subset of new release records whose selection scores exceed a threshold and stores or forwards this subset as user-specific candidate content.

### Step 9:

The server constructs a prompt sentence for a generative AI model based on the selected new release records and preference information.

The server receives, as input, the ranked subset of new release records, the user's preference information, and configuration data defining prompt templates.

The server performs text processing by inserting creator names, titles, categories, and key attributes into a template and by adding instructions that specify style, length, and focus of the desired output.

The server outputs a prompt sentence such as “You are a recommendation assistant for a content distribution platform. Using the following new releases, write one concise notification text (no more than 200 characters) that will attract a user who prefers modern jazz. Focus on the creator names and the mood of the tracks. Output only the final sentence.” and associates the prompt with structured context data.

### Step 10:

The server inputs the prompt sentence and context data into the generative AI model and obtains generated text.

The server takes, as input, the constructed prompt sentence and a structured representation of the selected new release records.

The server encodes the combined input into tokens, forwards the token sequence to a generative AI model implemented as a multi-layer neural network, and receives, as output, a sequence of tokens corresponding to a promotion text or a recommendation text.

The server decodes the token sequence into a natural-language string and stores or forwards the string as generated text associated with the selected new release records.

### Step 11:

The server generates notification information combining structured attributes and generated text.

The server receives, as input, the selected new release records and the generated promotion or recommendation text.

The server constructs a compact notification data structure including content identifiers, summarized attributes, and at least one generated text string, and may apply data compression or field omission to reduce size.

The server outputs notification information formatted for delivery to the terminal.

### Step 12:

The server transmits the notification information to the terminal in real time.

The server takes, as input, the notification information and a terminal identifier or communication token associated with the user.

The server selects an appropriate communication path, encapsulates the notification information in a transmission protocol format, and sends the encapsulated message over the communication network.

The server outputs a delivery status record indicating whether the terminal has accepted or rejected the transmission.

### Step 13:

The terminal receives and displays the notification information to the user.

The terminal receives, as input, the notification information transmitted from the server.

The terminal decodes the data, maps fields such as title, creator, and generated text to user interface elements, and displays a notification panel or a list view on the display.

The terminal outputs visual content and interactive controls that allow the user to open details, start reproduction, or input evaluation feedback.

### Step 14:

The user interacts with the notification information and content via the terminal.

The user receives, as input, the displayed notification panel or list view.

The user performs operations such as tapping an item to start reproduction, selecting a rating, or marking an item as not relevant.

The user outputs, through these actions, operation signals that are captured by the terminal as event information.

### Step 15:

The terminal converts user interactions into operation information and transmits it to the server.

The terminal receives, as input, low-level interaction events such as button presses, list selections, and playback control activations.

The terminal aggregates these events into operation information including a user identifier, notification identifier, content identifier, operation type, and timestamp, and encapsulates the operation information in a transmission-ready structure.

The terminal outputs the operation information by sending it to the server via the communication interface.

### Step 16:

The server computes evaluation indices from accumulated operation information.

The server takes, as input, multiple instances of operation information over time, including open events, click events, reproduction events, and evaluation events.

The server aggregates the data per prompt configuration, per generated text variant, and per content category, and calculates evaluation indices such as open rate, click-through rate, reproduction start rate, average reproduction duration, and average evaluation score.

The server outputs evaluation indices stored in association with specific prompt configurations and generative AI operation parameter sets.

### Step 17:

The server adjusts prompt configurations and generative AI operation parameters based on evaluation indices.

The server receives, as input, the evaluation indices and current prompt configurations and parameter values such as temperature and maximum output length.

The server performs parameter update computations, for example, by increasing weights of prompt variants with higher engagement metrics, decreasing temperature where high variance correlates with low performance, or modifying instruction phrases that show low effectiveness.

The server outputs updated prompt templates and updated generative AI parameter values, which are stored for use in subsequent executions of prompt construction and text generation.

### Step 18:

The server generates meeting-material data based on normalized new release information and, optionally, generated texts.

The server takes, as input, the internal-format data set, filtered subsets of new release records, and optionally promotion or recommendation texts.

The server organizes the data into sections according to pre-defined document structures, groups records by category or priority, and embeds summary texts generated by the generative AI model using dedicated prompt sentences such as “Create a short editorial summary for the following week's new releases for an internal programming meeting. Emphasize trends in the jazz and pop categories, and describe potential audience reactions in three bullet points.”

The server outputs meeting-material data in a structured document format ready for rendering or distribution.

### Step 19:

The terminal or another client device retrieves and displays the meeting-material data for internal use.

The terminal receives, as input, the meeting-material data provided by the server.

The terminal renders the document structure on a display, enabling navigation through sections, inspection of new release listings, and reading of generated editorial summaries.

The terminal outputs visual representations that support internal decision-making while remaining synchronized with the same underlying normalized data that drives user-facing notifications.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In the field of information processing, preparation of meeting materials based on domain-specific data, such as content release information, is still largely carried out by manual or semi-manual workflows. Conventional systems typically export raw records from databases or external feeds and then rely on human operators to interpret the data, design document structures, define tables and charts, and format electronic documents such as spreadsheet files. As a result, the overall process is time-consuming, error-prone, and highly dependent on individual skills in both data handling and document design.

Furthermore, in existing document-generation systems, data processing and document templating are often decoupled. A computing device may provide programmable report templates, but the definition of such templates is usually static and must be designed in advance by a programmer or system administrator. When the underlying data schema, business requirements, or presentation preferences change, the templates must be manually updated in source code or configuration files. This static approach does not scale well to dynamic environments in which new data attributes or new analysis perspectives frequently appear.

In addition, generative AI models have recently been used to produce natural-language content. However, conventional uses of generative AI in document creation commonly focus on generating narrative text or simple layouts in an unstructured manner. These approaches do not tightly integrate the generative AI model with the structured data pipeline and do not produce machine-readable template definitions that can be programmatically mapped to complex, structured document formats such as multi-sheet spreadsheet files. As a consequence, a human operator still needs to translate AI-generated descriptions into concrete sheet configurations, column definitions, and chart specifications.

From a computer-technology perspective, there is no sufficient mechanism in the prior art to automatically transform structured data into meeting materials in a way that (i) programmatically extracts and aggregates data, (ii) leverages a generative AI model to create machine-readable template structures based on that data, and (iii) automatically maps those structures into a spreadsheet file format that includes multiple sheets, tables, and graphs. Existing systems do not provide a unified processing pipeline in which a processor can automatically generate, from structured data and AI-derived template information, a fully configured spreadsheet document that is immediately usable on terminal devices for review and editing.

Thus, there is a need for an improved computer-implemented system that integrates structured-data processing with generative AI-based template generation in a machine-readable form, and that automatically constructs spreadsheet-based meeting materials, thereby reducing manual intervention, improving processing efficiency, and enhancing the technical functionality of the underlying information processing system.

The specific processing by the specific processing unit 290 of the data processing device 12 in Example 2 is realized by the following means.

The present invention provides a server comprising a processor and a memory storing instructions that, when executed by the processor, cause the processor to receive structured data including work-related information acquired from a plurality of information sources and store the structured data in a storage region; convert the stored work-related information into machine-readable intermediate data by using a data-processing program and perform data-processing operations including set operations and attribute extraction on the intermediate data; automatically generate a prompt sentence for input to a generative AI model on the basis of a summary of the intermediate data and configuration conditions of meeting materials, and transmit the prompt sentence to the generative AI model to obtain structural information of a meeting-material template in a machine-readable format; decompose the structural information into sheet-level and item-level definitions and hold mapping information from the sheet-level and item-level definitions to a spreadsheet file format; automatically generate meeting materials in the spreadsheet file format on the basis of the structural information of the meeting-material template and the intermediate data, including automatically determining configurations of graph objects and table objects on the basis of summary information generated by aggregation processing on the intermediate data and embedding the graph objects and the table objects into the spreadsheet file format; and distribute the automatically generated meeting materials to a terminal device via a communication network for display or editing in the terminal device. This enables an integrated computer-implemented pipeline in which structured data is transformed into intermediate data, a generative AI model is programmatically directed to produce machine-readable template structures, and the resulting structures are automatically mapped into a multi-sheet spreadsheet document with tables and graphs, thereby reducing manual operations, lowering processing latency, and improving the technical performance and automation capability of the document-generation system.
The term “structured data” refers to data that is organized according to a predefined schema, including identifiable fields and data types, so that the data can be programmatically parsed, queried, and processed by a computing device.
The term “work-related information” refers to information describing items or entities handled in a business or operational process, including, for example, identifiers, titles, dates, categories, descriptive texts, and other attributes associated with such items or entities.
The term “information source” refers to any system, service, storage, or interface from which work-related information can be obtained, including network services, databases, file repositories, and application programming interfaces.
The term “storage region” refers to a logical or physical area of a memory device, such as a main memory or a secondary storage, that is configured to store data for access and processing by a processor.
The term “data-processing program” refers to a software component executed by a processor that reads input data, performs one or more computational operations or transformations on the data, and outputs processed data suitable for subsequent use.
The term “machine-readable intermediate data” refers to data that has been transformed from an original input format into a standardized internal representation that can be directly processed, analyzed, and manipulated by a computing device without further human interpretation.
The term “set operation” refers to a data-processing operation that treats collections of records as sets and performs operations such as selection, union, intersection, difference, grouping, or joining on those collections.
The term “attribute extraction” refers to a data-processing operation in which specific fields, properties, or features are selected, derived, or normalized from input data and represented explicitly as attributes in the processed data.
The term “summary of the intermediate data” refers to aggregated or condensed information derived from the intermediate data, including, for example, counts, distributions, grouped statistics, or key indicators that characterize the underlying data set.
The term “configuration conditions of meeting materials” refers to requirements or constraints that specify the desired structure, content, layout, or presentation style of meeting materials, including, for example, required sections, tables, charts, and data fields.
The term “prompt sentence” refers to one or more machine-interpretable textual expressions transmitted to a generative AI model in order to specify a requested output, including instructions, constraints, and contextual descriptions.
The term “generative AI model” refers to a computational model implemented by software and executed on one or more hardware processors, which is trained on example data to generate new data, such as text or structured descriptions, in response to an input including a prompt sentence.
The term “structural information of a meeting-material template” refers to information that describes the organization of meeting materials, including definitions of sections, sheets, tables, fields, and relationships among them, in a manner that can be interpreted and applied by a computing device.
The term “meeting-material template” refers to a reusable structural pattern for meeting materials, specifying how data and content should be arranged, without necessarily including all of the final data values.
The term “machine-readable format” refers to a representation of information that can be automatically parsed and processed by a computing device according to a defined syntax or data model, such as a structured text format, a markup language, or a serialized data format.
The term “sheet-level definition” refers to a portion of the structural information of a meeting-material template that specifies properties of an individual sheet or section within a multi-part document, including, for example, a sheet name and the types of content allocated to the sheet.
The term “item-level definition” refers to a portion of the structural information of a meeting-material template that specifies details of individual data items or fields, including, for example, column names, data types, display formats, and logical meanings.
The term “mapping information” refers to information indicating how elements defined in the structural information, including sheet-level and item-level definitions, correspond to specific constructs or positions in a target file format, such as cells, rows, columns, and sheets in a spreadsheet file.
The term “spreadsheet file format” refers to a structured electronic document format that represents data in a tabular form using cells arranged in rows and columns, and that may support multiple sheets, formulas, formatting, and embedded objects such as charts.
The term “meeting materials” refers to electronic documents or files prepared for use in a meeting, including tables, summaries, charts, and descriptive fields that present information needed for discussion or decision-making.
The term “header row” refers to one or more rows in a tabular layout that contain labels or titles identifying the meaning of columns or data fields in the rows below.
The term “detail row” refers to a row in a tabular layout that contains actual data values or records corresponding to specific items, as distinguished from header rows or summary rows.
The term “summary information” refers to data that consolidates or aggregates multiple detail records into higher-level indicators, such as totals, averages, counts, or grouped statistics.
The term “communication network” refers to any wired or wireless infrastructure that enables data transmission between computing devices, including local area networks, wide area networks, and public networks.
The term “terminal device” refers to a user-operated computing device that can receive, display, and optionally edit electronic documents, including, for example, personal computers, tablet devices, and smart phones.
The term “graph object” refers to a visual representation of numerical or categorical data, such as a chart or diagram, embedded in an electronic document and generated from underlying data values.
The term “table object” refers to a structured representation of data arranged in rows and columns within an electronic document, often with formatting that differentiates headers, detail rows, and summary rows.
The term “aggregation processing” refers to a computation that combines multiple data records to produce a reduced set of summary values according to a defined aggregation function, such as summing, counting, averaging, or grouping by one or more keys.

In one embodiment, a server, a terminal, and a user cooperate to implement the invention. The server includes one or more processors, a main memory, a non-volatile storage device, a network interface, and an operating system such as a general-purpose server operating system. The server executes application software including a data acquisition module, a data processing module, a generative AI interface module, a template interpretation module, and a document generation module. The server also executes system libraries and third-party libraries such as a data-frame processing library (for example, a tabular data analysis library), a spreadsheet manipulation library, and an HTTP client library. The terminal includes a processor, a memory, a display unit, an input unit, and communication software such as a web browser or a native application capable of downloading and displaying spreadsheet files.

The server stores in its non-volatile storage device instruction sequences forming a program that, when loaded into the main memory and executed by the processor, implement the functional blocks described in the claims. The user deploys these programs to the server by transferring program files over a network or removable storage and by configuring environment variables, configuration files, and scheduling information. The user prepares connection settings for external information sources, such as network endpoints for content feeds, identifiers for database instances, authentication credentials, and parameters for a generative AI model endpoint.

The server uses the data acquisition module to obtain structured data that includes work-related information from multiple information sources. The server accesses, by means of the network interface, external computing resources such as remote application servers, storage services, and database services. The server uses an HTTP client library to issue requests to web-based interfaces, a file transfer library to download files if needed, and operating system calls to access local or mounted storage. The server stores retrieved raw data, such as comma-separated data or spreadsheet files, in a storage region specified in the file system.

The server uses the data processing module, implemented as software executed by the processor, to read the stored raw data and convert it into machine-readable intermediate data. The server loads the raw data into a tabular representation such as an in-memory data frame structure. The data frame structure stores records as rows and attributes as columns, with explicit data types for each column. The server performs data-type normalization, including converting text-based date strings into internal timestamp representations, unifying category labels, and standardizing character encodings. The server executes specific data-processing operations such as filtering records based on date ranges, selecting a subset of attributes required for later analysis, and joining multiple data sources on key attributes.

The server uses a set of algorithms to carry out set operations and attribute extraction. For example, the server applies grouping operations to aggregate records by a chosen key, such as a category or a time interval, and applies aggregation functions such as count, sum, or average to obtain summary metrics. The server uses indexing structures associated with the data frame to perform such grouping and aggregation in a cache-efficient manner, reducing the number of memory accesses compared to naive per-record iteration. The server produces intermediate data that separates summary representations (for example, counts by category or time) from detail representations (for example, one record per work item).

The server uses the generative AI interface module to form a prompt sentence for a generative AI model. The server generates the prompt sentence on the basis of the intermediate data and on configuration conditions supplied by the user. The server does not simply embed the raw data into the prompt sentence; instead, the server forms a compact numerical and textual summary that contains only relevant distributions and attribute names. For example, the server derives from the intermediate data a list of attribute names such as “work identifier,” “title,” “category,” “scheduled date,” and “description,” and computes statistical summaries such as the number of items per category and the range of scheduled dates. The server embeds these summaries and attributes into a structured textual instruction that guides the generative AI model toward a useful template structure.

The user can specify, via the terminal, high-level requirements for the meeting-material template. The user may select which attributes to emphasize, which types of summary views to include, and whether charts are required. The server combines those configuration conditions with the data-derived summaries to generate a more precise prompt sentence. For example, the user may provide a prompt sentence such as:
“Create a detailed template for a weekly meeting document based on new work release information. The template should include: a summary sheet with the number of works per category and per week, a detailed sheet with identifier, title, category, release date, and description, and a decision sheet for recording selection decisions and comments.”

In another example, the user may provide a prompt sentence such as:
“Design an Excel template for analyzing upcoming release items. Include separate sheets for summary statistics, detailed listings, and decision tracking, with appropriate column names and sections for charts.”

The server transmits the generated prompt sentence to a generative AI model executed either on the same server or on an external computing platform accessible via the network interface. In one embodiment, the generative AI model is implemented as a deep neural network with a transformer architecture including multiple attention layers, feed-forward layers, and layer-normalization components. The generative AI model is stored as a collection of weight matrices in memory and is executed by a hardware accelerator such as a graphics processing unit or a tensor processing unit, or by a multicore central processing unit when an accelerator is not available.

The generative AI model is trained in advance by a training system separate from the production server. The training system uses a corpus of text and structured examples that associate prompt sentences with desired template descriptions, including sheet definitions, field definitions, and layout hints. During training, the system applies a learning algorithm such as stochastic gradient descent or an adaptive variant to minimize a loss function that measures cross-entropy between predicted tokens and ground-truth tokens. The system updates model parameters by backpropagating the error through attention layers and feed-forward layers. The training process may include regularization techniques, such as dropout and weight decay, and data augmentation, such as paraphrasing of template descriptions and variation of attribute names.

The server, in production, uses the trained generative AI model in inference mode. The server formats the prompt sentence as a sequence of tokens and provides them as input to the model. The model processes the sequence by computing attention scores between tokens and by applying learned weight matrices to generate output tokens that represent structural information of the meeting-material template. The server receives the output as structured text, which may be expressed, for example, as a machine-readable description of sheets and fields. The server may instruct the model via the prompt sentence to output a clearly delimited structural format, such as a list of sheet names followed by a list of field names for each sheet, so that the server can parse the result deterministically.

The server uses the template interpretation module to parse the structural information received from the generative AI model. The server identifies tokens corresponding to sheet-level definitions and tokens corresponding to item-level definitions. The server creates an internal representation such as a hierarchical structure in memory, where a top-level list corresponds to sheets and each sheet contains a list of field definitions. Each field definition includes attributes such as a logical name, a preferred data type, a suggested display width, and a recommended ordering. The server then constructs mapping information that associates each logical field with a specific column index in a spreadsheet sheet and associates each sheet-level definition with a specific sheet index or name.

The server uses the document generation module, which interacts with a spreadsheet manipulation library, to construct an actual spreadsheet file. The server creates a new workbook object in memory and adds sheets based on the sheet-level definitions. The server assigns to each sheet a name specified by the template. The server then creates a header row for each sheet by writing field names into the cells of the first row, and applies formatting such as boldface, background color, and column width adjustments. The server maps each attribute in the intermediate data to the appropriate column position using the mapping information generated by the template interpretation module.

The server populates the sheets with detail rows by iterating over the intermediate data. For each record in the detail-level intermediate data, the server computes the row index and writes attribute values into corresponding cells. The server converts internal data types such as timestamps into display formats appropriate for the spreadsheet cells, and the server ensures that numeric values used for later computation are written as numeric cell types rather than as plain text. The server may also insert formulas into certain cells, for example to compute totals or derived metrics directly within the spreadsheet.

The server generates summary information by executing aggregation operations on the intermediate data, such as counting the number of items per category or per time interval. The server writes the resulting summary tables into designated regions of the summary sheet. The server then creates graph objects such as bar charts or line charts by specifying the ranges of cells that contain the summary data. The spreadsheet manipulation library converts the specification of graphs into embedded chart objects according to the spreadsheet file format specification. The server assigns positions, sizes, and chart types based on both the structural information from the generative AI model and predefined heuristics implemented in the document generation module.

The server stores the generated spreadsheet file in a file system accessible by the server. The server may compress the file if required by the communication protocol or by storage constraints. The server then uses a network server component, such as a web server process or an application server, to deliver the generated file to the terminal over a communication network. The server may expose a URL for the file or send it as an attachment via a communication protocol. The server also records in a log or metadata database the time of generation, the configuration parameters, and identifiers for the data sources and the generative AI model version.

The terminal receives the spreadsheet file from the server over the network interface. The terminal stores the file in local storage and opens it using spreadsheet display software, which may be a native spreadsheet application or a browser-based viewer. The terminal decodes the spreadsheet format and renders the sheets, tables, and graphs on the display. The user operates an input device to scroll through the sheets, inspect the summary charts, and edit cell values. The user can update decision fields, annotate specific items, and adjust priorities. The terminal saves edited versions of the file locally and may upload the edited file back to the server or to a shared storage service for further processing.

The described architecture improves computer technology in several ways. The server reduces the number of interactions between the data storage subsystem and the document rendering subsystem by introducing an intermediate data structure optimized for both analytics and template mapping. This reduces memory copies and redundant parsing steps, thereby lowering processing latency and improving throughput for large data sets. The server also constrains the generative AI model to produce machine-readable structural descriptions rather than free-form narrative text. This constraint is enforced through the prompt sentence and through post-processing logic that validates output structure. By doing so, the server transforms the generative AI output into a deterministic input for the spreadsheet generation algorithms, which enhances reliability and reduces the need for error-prone manual intervention.

The system also improves data management and computational efficiency. By applying grouping and aggregation on the intermediate data before transmitting any contextual summary to the generative AI model, the server reduces the size of the prompt sentence and thereby reduces network traffic and inference time at the model side. This design choice leads to reduced communication load between the server and the external model host and lowers the overall computational resources required for template generation. The internal use of an indexed data frame to represent intermediate data enables vectorized operations on arrays, which improves cache locality and reduces instruction counts compared to a row-by-row interpreter-like approach.

The generative AI model, in combination with the template interpretation module, implements a non-conventional pipeline that differs from human document design. A human operator typically inspects raw data visually and then manually drafts a template in a spreadsheet application. In contrast, the server first encodes data distributions into a compact representation, uses a trained transformer model to infer an optimal or suitable template structure, and then programmatically maps that structure into a file format. The transformer model learns patterns from many prior examples of templates and can produce a structural design that balances readability and information density. The server leverages this model in a standardized way that is not merely mimicking human operations, because it exploits model attention mechanisms to correlate attribute types and summary patterns with layout decisions that a rule-based system would find difficult to encode explicitly.

The training of the generative AI model reinforces this improvement. The training system uses datasets that pair inputs including attribute lists, summary statistics, and meeting objectives with outputs representing desirable template descriptions. The loss function measures differences between predicted token sequences and reference descriptions; the gradient is computed over attention layers and feed-forward layers, and the model parameters are updated accordingly. By including examples that cover a wide range of data schemas and layout requirements, the trained model gains the ability to generalize to unseen combinations, thereby providing, at inference time, template structures that would be difficult to design with fixed rules. The server thus utilizes the learned model as a technical component that transforms structured summaries into optimal template definitions.

The server may incorporate variations and alternative embodiments. In one variation, the server executes the generative AI model locally using a hardware accelerator, thereby reducing latency and providing additional control over inferencing parameters such as decoding temperature and output length. In another variation, the server uses an alternative model architecture, such as a recurrent neural network with attention mechanisms or a hybrid model that combines rule-based filtering with neural sequence generation. The server may also vary the internal representation of structural information, for example using an abstract syntax tree that encodes sheet hierarchies and field attributes.

In another embodiment, the server modifies the aggregation logic according to the data domain. For example, for time-series-oriented work items, the server may compute rolling averages or trend indicators and incorporate them into summary information. This leads to more effective chart placement and sizing within the spreadsheet. The server may also prioritize certain attributes when constructing mapping information, such as ensuring that identifiers and time-based attributes appear in the leftmost columns for improved scanning performance by readers.

The system provides technical effects including reduced processing time for large-scale data, improved accuracy of template mapping, and reduced error rates in the generated documents. By automating the mapping between AI-derived structural information and the spreadsheet file format using well-defined internal data structures and algorithms, the server avoids human transcription errors and ensures structural consistency across multiple document generations. The system also contributes to improved resource utilization by reducing redundant I/O operations and compressing prompt information before transmission to the generative AI model.

In summary, the server, the terminal, and the user cooperate in an architecture where the server executes specialized data-processing algorithms and a trained generative AI model to automatically design and populate structured meeting materials. The specific configuration of data frames, aggregation operations, prompt construction, template parsing, and spreadsheet generation implements an improvement in computer functionality, rather than merely automating a human mental process, and yields concrete technical advantages in terms of speed, reliability, and resource efficiency.

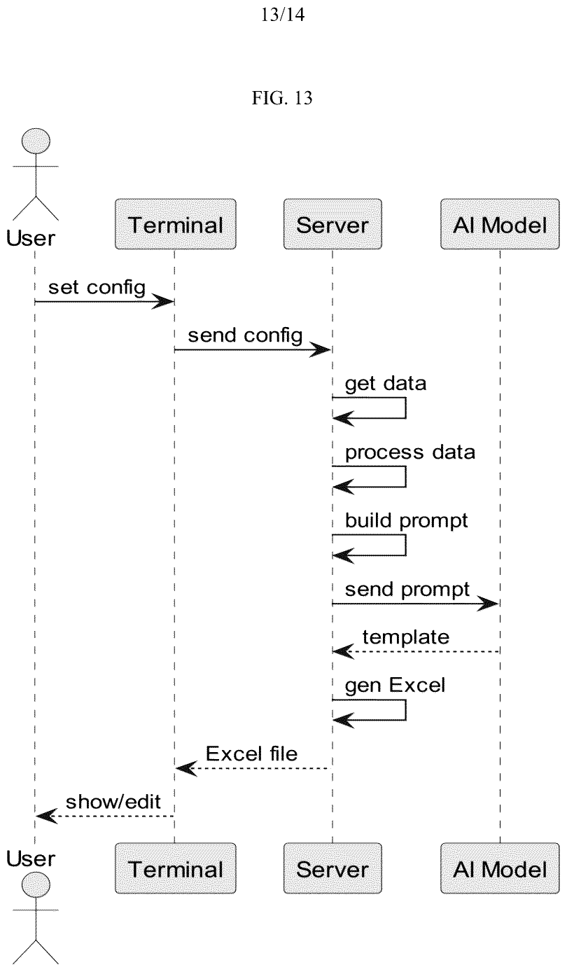

The following describes the processing flow using FIG. 13.

### Step 1:

User configures the system and provides initial settings.

User specifies, via the terminal, connection information for information sources, storage locations on the server, target time ranges, and requirements for meeting materials (for example, which attributes to include and which summaries or charts are needed). As input, the user provides configuration parameters such as endpoint URLs, authentication credentials, attribute selection lists, and meeting objectives. Based on this input, the server records structured configuration data in a configuration storage region. The output of this step is a set of stored configuration records that the server uses as control parameters for subsequent data acquisition and processing.

### Step 2:

Server acquires raw work-related data from multiple information sources.

Server reads the configuration records and, using the network interface and operating system calls, connects to external systems such as web services, file servers, or databases. As input, the server uses the configured endpoints and credentials. The server sends HTTP requests, initiates file transfers, or issues database queries to retrieve raw data sets such as CSV files, spreadsheet files, or result sets. The server stores these raw data sets in a designated raw-data directory or database table. During this process, the server logs the time, size, and source of each acquisition. The output of this step is a collection of raw data files or raw tables containing unnormalized work-related information.

### Step 3:

Server converts raw data into an internal tabular representation.

Server loads each raw data file or raw table into an in-memory data-frame structure. As input, the server uses the raw data collection generated in Step 2. The server parses delimiters, header rows, and data types, converting textual values into typed fields such as integers, floating-point numbers, and timestamps. The server renames columns to standardized logical names based on mapping rules stored in the configuration. The server also handles missing values by applying fill rules (for example, default strings) or by marking records with missing critical attributes. The output of this step is an internal data frame containing normalized records with consistent column names and data types, ready for further processing.

### Step 4:

Server performs attribute extraction and filtering on the internal data.

Server applies attribute selection criteria derived from the configuration and from built-in rules. As input, the server takes the normalized data frame from Step 3. The server discards irrelevant columns and retains only attributes required for meeting materials, such as identifiers, titles, categories, scheduled dates, and descriptions. The server filters rows based on conditions, for example, by selecting only items whose scheduled dates fall within a configurable time window. The server may also compute derived attributes, such as week numbers or category groups, by applying arithmetic and date functions to existing fields. The output of this step is a reduced and enriched data frame that contains only relevant and correctly typed attributes for the target period.

### Step 5:

Server generates summary statistics for template guidance.

Server computes aggregate information from the filtered data. As input, the server uses the reduced data frame from Step 4. The server groups records by one or more keys, such as category, label, or week, and then applies aggregation functions such as count, min, max, or average to produce summary tables. The server may, for example, compute the number of items per category per week and the earliest and latest scheduled dates for each category. The server stores these summary tables as separate internal data structures. The output of this step is a set of summary data frames that compactly represent the distribution and characteristics of the underlying detailed data.

### Step 6:

Server constructs a prompt sentence for the generative AI model.

Server combines configuration information, attribute lists, and summary statistics into a textual instruction. As input, the server uses the user-specified meeting objectives, the attribute metadata from Step 4, and the summary tables from Step 5. The server formats a prompt sentence that describes the purpose of the meeting materials, enumerates key attributes, and specifies required sections such as summary sheets, detail sheets, and decision sheets. The prompt sentence also requests a structured description of sheet names and column headings. For example, the server may generate or incorporate a user-provided prompt sentence such as:
“Create a detailed template for a weekly meeting document based on new work release information. The template should include: a summary sheet with the number of works per category and per week, a detailed sheet with identifier, title, category, release date, and description, and a decision sheet for recording selection decisions and comments.”

The output of this step is a composed prompt sentence that encodes both user intent and data-driven context.

### Step 7:

Server sends the prompt sentence to the generative AI model and receives structural information.

Server transmits the prompt sentence to a generative AI model endpoint via a network request. As input, the server uses the prompt sentence generated in Step 6 and a model identifier specifying a transformer-based language model. The generative AI model, executing on a processor or accelerator, processes the prompt and generates an output sequence that describes a meeting-material template in a machine-readable textual structure (for example, a structured list of sheet names and field names). The server receives this output as a text response over the network. The output of this step is a raw structural description generated by the generative AI model that encodes one or more sheets, their relationships, and their fields.

### Step 8:

Server parses and interprets the structural description into internal template definitions.

Server analyzes the text returned by the generative AI model. As input, the server uses the raw structural description from Step 7. The server applies parsing rules and pattern-matching logic to identify boundaries between sheet definitions and fields. The server creates an internal template representation, for example, a hierarchical structure where each sheet object contains a list of field objects with associated labels, data-type hints, and ordering information. The server also resolves synonyms or ambiguous wording by matching field labels to known attribute names in the internal schema. The output of this step is a set of template definitions containing sheet-level and item-level structures that can be directly mapped to spreadsheet constructs.

### Step 9:

Server generates mapping information between template fields and internal data attributes.

Server aligns the template definitions with the intermediate data attributes. As input, the server uses the internal template representation from Step 8 and the attribute metadata from Step 4. The server compares field labels from the template to attribute names and synonyms, calculates similarity scores, and selects the best matches according to predefined matching rules. The server assigns column indices within each sheet to specific attributes and records layout information such as column order and initial column width. The server stores this mapping as a data structure that associates each field in the template with a column in the spreadsheet and a source attribute in the intermediate data. The output of this step is a mapping table that drives the population of spreadsheet cells.

### Step 10:

Server creates a new spreadsheet workbook and configures sheets and headers.

Server instantiates a new spreadsheet file object in memory via a spreadsheet manipulation library. As input, the server uses the template definitions and mapping information from Step 9. The server creates one sheet per sheet-level definition and assigns the specified sheet names. The server then writes header rows by iterating over the field definitions and placing field labels into the first row of each respective sheet at the mapped column indices. The server applies basic formatting, such as setting font style, border lines, and column width. The output of this step is an in-memory spreadsheet workbook with correctly named sheets and configured header rows.

### Step 11:

Server populates detail rows with intermediate data.

Server fills the spreadsheet sheets with row-level data derived from the intermediate data. As input, the server uses the reduced and enriched data frame from Step 4 and the mapping table from Step 9. The server iterates over each record in the data frame, determines the target sheet (for example, a detail sheet) based on the template, and for each attribute, retrieves the corresponding cell position from the mapping table. The server then writes converted values into the cells, converting internal representations such as timestamps to appropriate spreadsheet formats. If configured, the server writes formulas into specific cells, for instance to compute row-level derived values. The output of this step is a spreadsheet workbook that includes fully populated detail tables reflecting the input data.

### Step 12:

Server computes summary tables for the spreadsheet and writes them to summary sheets.

Server takes the summary data frames produced in Step 5 and places them into designated regions of one or more summary sheets. As input, the server uses those summary tables and the mapping information that identifies summary sheet locations. The server writes group keys and aggregated metrics into the appropriate columns and rows, ensuring that labels and numeric values are distinguished. The server may also generate additional summary metrics at this stage, such as cumulative totals or percentage distributions, by applying arithmetic operations to the aggregated numbers. The output of this step is a set of summary tables embedded in the spreadsheet file.

### Step 13:

Server generates graph objects and embeds them into the spreadsheet.

Server creates charts based on summary tables. As input, the server uses the cell ranges of the summary tables written in Step 12 and chart configuration hints from the template definitions. The server specifies chart types (for example, bar, line, or pie charts), assigns data ranges for axes and series, and configures labels and legends. The spreadsheet manipulation library converts these specifications into graph objects embedded in the corresponding summary sheets. The server positions and sizes the charts according to layout rules, such as placing them below or beside the related tables. The output of this step is a spreadsheet workbook that includes both tabular data and embedded chart objects.

### Step 14:

Server finalizes the spreadsheet file and stores it for distribution.

Server serializes the in-memory workbook into a file in a standardized spreadsheet file format. As input, the server uses the completed workbook from Steps 11 to 13. The server writes the file to a designated output directory or storage service, optionally compressing the file if required. The server also records metadata such as file name, generation time, template version identifier, and data source identifiers in a metadata store. The output of this step is a persistent spreadsheet file that can be accessed by external clients.

### Step 15:

Server distributes the generated spreadsheet file to the terminal.

Server exposes the generated file to the terminal via a network-accessible interface. As input, the server uses the file path and metadata produced in Step 14. The server may return a download link via a web response, send the file as an attachment through a messaging protocol, or place it in a shared storage location and notify the terminal of its location. The server logs access events and ensures that appropriate permissions are enforced. The output of this step is the successful transmission of the spreadsheet file or of a file reference to the terminal.

### Step 16:

Terminal receives and opens the meeting-material file.

Terminal connects to the server using a communication protocol such as HTTP or another supported protocol. As input, the terminal uses the file reference or download link provided by the server in Step 15. The terminal downloads the spreadsheet file and stores it locally. The terminal launches spreadsheet software or a viewer, loads the file, and renders the sheets, tables, and graphs on the display. The output of this step is a visual presentation of the meeting materials to the user, with editable cells and interactive charts.

### Step 17:

User reviews and optionally edits the meeting materials on the terminal.

User inspects the contents of the summary and detail sheets. As input, the user uses the rendered spreadsheet displayed on the terminal. The user may modify specific cells, such as decision fields, comments, or priority indicators, by typing new values through an input device. The user may also insert additional annotations or highlight particular rows and columns. The terminal updates the in-memory representation of the spreadsheet and, upon saving, writes the updated file to local storage or back to a shared location. The output of this step is an updated spreadsheet file reflecting the user's decisions and annotations, ready for use in actual meetings or for further processing by the server if needed.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In many business domains, such as logistics, manufacturing, content distribution, and marketing, computer systems are required to generate documents including meeting materials, reports, and promotional texts from large volumes of heterogeneous digital data. Conventional systems typically rely on fixed templates and manually designed rules to transform stored data into human-readable documents. Such rule-based pipelines are rigid and require frequent manual maintenance whenever data schemas, business requirements, or document styles change. As a result, the overall document generation workflow is brittle, expensive to maintain, and slow to adapt to new tasks.

Further, although generative AI models can produce natural language content from prompt sentences, conventional systems generally treat prompts as static, manually crafted strings, separate from the existing data processing pipeline. These static prompts are not automatically adapted to the current state of enterprise data, user attributes, or user behavior. Consequently, the generated content may fail to accurately reflect the most recent data or the specific needs and preferences of individual users. This leads to inefficiencies, such as repeated post-editing, inconsistent document quality, and delayed delivery of information.

Moreover, existing systems often ignore user interaction signals that are already available in the computing environment, such as viewing history, operation history, and editing history on terminal devices. Even where user behavior is logged, it is rarely fed back into the prompt construction process or the configuration of the underlying generative AI model. As a result, conventional systems cannot effectively estimate user emotional states or preference states, and therefore cannot adapt the generated content or its presentation order in a data-driven manner. This limitation reduces the effectiveness of recommendations, event notifications, and personalized document delivery, and represents an under-utilization of available computational resources and logged interaction data.

From the viewpoint of computer technology, there is thus a need for an improved information processing architecture that tightly integrates: (i) structured acquisition and aggregation of task-related digital data from multiple information sources; (ii) dynamic construction of prompt sentences that embed intermediate data and analysis conditions; (iii) automatic invocation of a generative AI model to produce natural language content; and (iv) closed-loop adaptation based on user interaction histories. Without such an integrated architecture, processors and storage devices are not used optimally, network resources are consumed by redundant or low-relevance content, and the overall responsiveness and robustness of the document generation pipeline remain limited. The technical problem to be solved is therefore to improve the way in which a computer system processes multi-source digital data, constructs prompts, and interacts with generative AI models and terminal devices, so as to efficiently generate and deliver data-consistent, user-adaptive documents while reducing manual intervention and computational waste.

The specific processing by the specific processing unit 290 of the data processing device 12 in Application Example 2 is realized by the following means.

The present invention provides a server comprising a processor configured to acquire task-related information from a plurality of information sources, convert the task-related information into a predetermined data structure, and store the converted task-related information in a storage device; aggregate and analyze the stored task-related information by using a statistical processing program to generate intermediate data usable for creation of a meeting document, a report document, or a promotional document; dynamically construct a prompt sentence for a generative AI model on the basis of the intermediate data and user attribute information or user behavior history information, and embed the intermediate data and analysis conditions into the prompt sentence; input the prompt sentence to the generative AI model and cause the generative AI model to automatically generate natural language content including meeting-document text, report-document text, or promotional text; place the automatically generated natural language content into a document template or a screen template to generate document data in a predetermined format, and provide the document data to a terminal device via a communication network; obtain viewing history, operation history, or editing history performed by a user from the terminal device, and estimate an emotional state or a preference state of the user on the basis of the history; control content of the prompt sentence for the generative AI model or a presentation order of the document data in accordance with the estimated emotional state or preference state; and generate and transmit notification data to the terminal device in order to notify event information or recommendation information related to the emotional state or preference state. This enables the computer system to implement a closed-loop, data-driven document generation pipeline in which multi-source digital data are transformed into intermediate representations, dynamically embedded into prompt sentences, processed by a generative AI model, and adaptively refined based on user interaction histories, thereby improving the efficiency, responsiveness, and personalization capability of the underlying information processing infrastructure.

The term “task-related information” refers to digital data that is relevant to execution of a business task or operation, including but not limited to operational records, configuration data, log data, and metadata obtained from one or more information sources.
The term “information source” refers to any hardware or software system that provides task-related information, including databases, application programming interfaces, file servers, sensor systems, or message streams.
The term “data structure” refers to an organized representation of digital data in a predetermined format, such as a record, table, tree, graph, or document structure, suitable for storage and processing by a computer.
The term “storage device” refers to a physical or virtual data storage component used by a computer system to retain digital information, such as a magnetic storage unit, a semiconductor storage unit, an optical storage unit, or a network-attached storage system.
The term “statistical processing program” refers to software that performs numerical operations, aggregation, computation of metrics, or other data analysis on digital data, including spreadsheet software, data analysis libraries, or statistical computing environments.
The term “intermediate data” refers to processed data generated from raw task-related information, which has been aggregated, normalized, or transformed and is suitable as an input or context for further processing, such as document generation.
The term “meeting document” refers to a digital document or dataset prepared to support a meeting, conference, or discussion, including agendas, summaries, analytical tables, and explanatory texts.
The term “report document” refers to a digital document that summarizes analysis results, operational status, or performance indicators, and that is intended for review by stakeholders or decision makers.
The term “promotional document” refers to a digital document, text, or content item that is intended to promote products, services, or content, including advertising copy, marketing descriptions, and recommendation texts.
The term “user attribute information” refers to information that characterizes a user, including profile data, demographic information, role information, usage context, or configuration preferences.
The term “user behavior history information” refers to records of operations performed by a user in relation to a system or content, including viewing history, operation history, editing history, playback history, click history, or other interaction logs.
The term “prompt sentence” refers to a machine-readable input expression, including natural language text, structured text, or a combination thereof, that instructs a generative AI model regarding a desired output, such as content type, style, structure, or constraints.
The term “generative AI model” refers to a computational model that generates data, such as natural language text, in response to an input prompt, the model typically being trained using machine learning or deep learning techniques on large datasets.
The term “natural language content” refers to text data expressed in a human language and generated or processed by a computer system, including sentences, paragraphs, lists, tables, and document sections.
The term “document template” refers to a predefined digital structure for a document, including layout definitions, placeholders, and formatting rules, into which generated content can be inserted.
The term “screen template” refers to a predefined digital layout for presenting information on a display device, including arrangement of user interface elements, text regions, and graphical components.
The term “document data” refers to digital data representing a document in a predetermined format, including structured text, markup, layout instructions, and associated metadata, suitable for storage, transmission, or rendering.
The term “communication network” refers to a collection of communication links and nodes that enable data exchange between devices, including wired networks, wireless networks, local networks, and wide-area networks.
The term “terminal device” refers to a computing device operated by a user to access or interact with the system, including mobile devices, tablet devices, desktop computers, laptop computers, or other user-facing devices.
The term “viewing history” refers to digital records indicating which content items a user has viewed, when the viewing occurred, and optionally how long the viewing lasted or how the content was navigated.
The term “operation history” refers to digital records of user actions performed through a user interface, including selections, inputs, clicks, scrolls, and playback controls.
The term “editing history” refers to digital records of modifications made by a user to content, including inserted, deleted, or changed text, fields, or structured elements.
The term “emotional state” refers to a computationally estimated representation of a user's affective condition with respect to content or tasks, such as positive, neutral, negative, or more detailed emotional categories or scores.
The term “preference state” refers to a computationally estimated representation of a user's liking or disliking for particular items, categories, or attributes, derived from interaction data or other signals.
The term “presentation order” refers to the sequence in which document data, content items, or user interface elements are arranged and presented to a user by a computer system.
The term “notification data” refers to digital information that encodes a message intended to alert or inform a user, including identifiers, titles, message bodies, and metadata for delivery via a notification mechanism.
The term “event information” refers to data describing an occurrence or planned occurrence of interest, including, for example, time, place, participants, subject matter, and associated content identifiers.
The term “recommendation information” refers to data describing items or actions that are suggested to a user, such as content items, products, services, or events that the system determines to be relevant based on analysis.
The term “evaluation index” refers to a numerical or categorical measure calculated from user interaction data, system performance data, or outcome data, and used to assess quality, relevance, or effectiveness of generated content or processing steps.
The term “generation rules of the prompt sentence” refers to procedures, parameters, or patterns used by the system to construct a prompt sentence from underlying data, including selection of fields, phrasing, structure, and constraints.
The term “parameters of the generative AI model” refers to adjustable numerical values or configuration settings internal to the generative AI model that determine its behavior and output characteristics.

In one embodiment, server implements the claimed system as a network-connected information processing apparatus including at least one multi-core central processing unit (CPU), a volatile memory, a non-volatile storage device, a graphics processing unit (GPU) for machine learning acceleration, and a network interface. Server executes an operating system such as a general-purpose server operating system and executes application programs written in a high-level programming language. Server connects to one or more terminal devices via a communication network such as a packet-switched network. Terminal is, for example, a smartphone, a tablet device, or a personal computer, and executes a client application or a web browser. User operates terminal to view, edit, and confirm document data and notification data provided by server.

Server stores task-related information received from multiple information sources in a structured manner. Server uses a relational database management system, such as a general-purpose relational database engine, as storage, and stores task-related information in normalized tables. Server uses a data manipulation library, such as a table-oriented data analysis library, on top of the operating system to read data from the database, perform grouping, aggregation, and statistical computations, and generate intermediate data. Server defines intermediate data as records in memory that include, for each business entity (for example, an item, a content identifier, or a product identifier), aggregated metrics such as counts, totals, averages, and computed indicators. By maintaining explicit data structures for intermediate data, server reduces redundant computation, improves cache locality, and reduces disk access compared to repeatedly scanning raw logs.

Server uses a generative AI model to convert intermediate data into natural language content. Server implements the generative AI model as a neural network model deployed either on server itself (for example, on the GPU) or on an external inference service accessible via an application programming interface. In one embodiment, the generative AI model is a transformer-based language model including multiple layers of self-attention blocks, feedforward units, and layer-normalization modules. The model uses wordpiece or subword tokenization to convert a prompt sentence and any embedded data into token sequences. The model predicts a next token distribution using a multi-head attention mechanism and a softmax output layer. Server configures model parameters, such as the number of layers, the number of attention heads, hidden dimension size, and vocabulary size, according to resource constraints of the hardware platform.

Server trains the generative AI model using a training dataset containing domain-specific texts, such as historical meeting minutes, reports, and promotional texts. Server minimizes a loss function, such as cross-entropy between predicted token distributions and ground truth tokens, and updates network weights by applying gradient-based optimization, such as stochastic gradient descent or adaptive moment estimation. Server optionally performs reinforcement learning or fine-tuning based on evaluation indices derived from user interaction histories, so that the generative AI model better reflects preferences of users and improves text quality over time. By performing training and fine-tuning in this manner, server improves the internal representation within the generative AI model and reduces the rate of incoherent or irrelevant outputs compared to a generic, non-adapted model.

Server constructs prompt sentences dynamically by combining fixed prompt templates with intermediate data and user-related information. Server maintains prompt templates as parameterized strings in memory or in a configuration store. Server fills placeholders in the template with textual summaries derived from intermediate data and with descriptors of desired output properties, such as length, structure, and style. For example, server generates a prompt sentence of the following form:
“Using the following weekly inbound and outbound quantities and stock changes, generate meeting materials that summarize key trends, identify risks such as potential stock-outs or overstock, and include a forecast for next week's inventory levels. Present the result as a structured report with headings and bullet points. Here is the data: [embedded data].”

In another embodiment, server generates a prompt sentence for new release information in the following form:
“Transfer the following new release information into a clean table format. For each release, output the artist name, album title, and release date. Normalize all dates to the format YYYY-MM-DD. Here is the raw data: [embedded data].”

In still another embodiment, server generates a prompt sentence for recommendation and promotion in the following form:
“Based on this user's recent listening history and positive reactions to specific artists, infer the user's emotional preferences and recommend ten new releases that match the user's taste. Also propose short promotional messages for each recommended track.”

In yet another embodiment, server generates a prompt sentence for advertising text in the following form:
“Generate a promotional text that strongly emphasizes the following product features: [feature list]. The tone should be friendly and persuasive, and the text should be suitable for an online advertisement. Length: about 150 words.”

Server converts intermediate data, such as aggregated tables, into textual summaries or formatted entries before embedding them in the prompt sentence. This conversion enables the generative AI model to interpret numerical context and produce consistent narrative descriptions. Because server generates prompt sentences using structured templates and current intermediate data, the prompts systematically reflect the latest state of the underlying data and reduce manual prompt engineering effort.

Server uses user behavior history information to estimate an emotional state or preference state of user. Terminal records viewing history, operation history, and editing history of user at a fine granularity, such as individual content identifiers, timestamps, durations, scroll depths, and click targets. Terminal periodically transmits these logs to server in the form of structured records. Server stores these logs in the database in event tables, where each record includes at least a user identifier, content identifier, event type, and time.

Server computes features from behavior logs. Server aggregates counts of specific actions (for example, repeat plays, long reads, skip events), dwell time on documents, frequency of edits, and acceptance ratio of generated texts. Server uses these features as input to an emotion estimation model. In one embodiment, server implements the emotion estimation model as a shallow neural network, such as a multilayer perceptron, that maps feature vectors to numeric scores representing several emotional dimensions (for example, positive engagement, boredom, dissatisfaction). The neural network includes one or more hidden layers with non-linear activation functions. Server trains the neural network by supervised learning using labeled interaction data, where past interactions are annotated, for example, by explicit feedback or inferred satisfaction indicators (such as continued use, minimal edits, or repeated opens).

In another embodiment, server combines the neural model with a rule-based estimator. Server defines rules such as “if a document generated for a given content is closed within a threshold time and no further related content is opened, reduce a satisfaction score for that content,” or “if a generated promotional text is used without modification and leads to a high click-through rate, increase a preference score for similar styles.” Server fuses rule-based signals with neural model outputs, for example by weighted averaging, to form a final emotional state and preference state for user. This hybrid approach improves robustness and interpretability: server can utilize explicit business logic and non-intuitive patterns learned from data.

Server stores emotional state and preference state in dedicated tables keyed by user identifier. These states are numerical vectors or categorical labels that server updates over time whenever new interaction data are received. Server uses these states as additional inputs to the prompt construction logic. For example, when emotional state indicates strong positive engagement with technical details, server adds instructions to the prompt sentence requesting “more detailed technical explanation and fewer general statements.” When preference state indicates that user favors concise executive summaries, server adds instructions requesting “a short summary section at the beginning with no more than three bullet points.”

By feeding emotional state and preference state into prompt construction and by updating them using objective interaction data, server creates a feedback loop between the generative AI model and the behavior of user. This feedback loop is implemented entirely through concrete data structures and computational steps, rather than through abstract human judgment, and leads to technical effects such as lower recomputation frequency, reduced network load caused by unused or rejected documents, and improved cache utilization for popular content profiles.

Server formats and delivers generated natural language content to terminal. Server uses document templates and screen templates, stored as structured layout definitions (for example, markup templates) that specify positions of headings, body text, tables, and navigation components. Server inserts AI-generated text into these templates based on semantic tags present in the model output, such as markers for sections and lists. Server then generates document data in predetermined formats, such as markup documents or page description formats, with references to style definitions. Server transmits the resulting document data to terminal via the communication network.

Terminal renders document data on a display device. Terminal decodes received markup or page description, applies style rules, and displays headings, sections, tables, and other elements. Terminal also provides editing interfaces that allow user to correct or modify AI-generated text. When user edits content, terminal records detailed editing operations, such as insertion, deletion, and replacement spans, and sends them as editing history to server. Server can use these editing histories to refine future prompt sentences and adjust generative AI model parameters, for instance by identifying systematic error patterns or by highlighting under-specified instructions.

Server generates and transmits notification data to terminal based on emotional state and preference state. Server uses event information stored in the database, such as scheduled meetings, upcoming product launches, or content releases, and matches them to user profiles by comparing identifiers and tags. Server formats notification messages as structured payloads containing a title, a short message body, and associated identifiers, and transmits them through a push notification protocol. Terminal receives the notifications, displays them to user, and reports back whether user opened or ignored them. Server can incorporate this notification response behavior into evaluation indices used for further tuning of generative AI model and prompt generation rules.

The architecture and processing described above provide several technical advantages. First, server reduces redundant processing by maintaining intermediate data in specific data structures that are reused across multiple document generation tasks. This improves processing speed and reduces computational overhead compared to repeated raw data scans. Second, by dynamically constructing prompt sentences from intermediate data and by embedding analysis conditions, server enables the generative AI model to generate texts that more directly reflect current data states, which improves alignment between generated passages and numerical summaries and reduces the need for manual verification. Third, by estimating emotional state and preference state from fine-grained interaction logs and feeding these estimates back into prompt construction and content presentation, server reduces the generation of unused or irrelevant content, thus decreasing communication load and storage usage.

Furthermore, server uses evaluation indices derived from user behavior, such as acceptance rate of generated content, edit distance between generated and final text, and notification open rates, to update parameters of the generative AI model or generation rules of the prompt sentence. Server computes these evaluation indices as numerical values based on interaction logs and stores them in metric tables. Server then applies optimization algorithms to adjust hyperparameters such as sampling temperature, maximum length, or penalty terms for repetition within the generative AI model's inference configuration. Server can also adjust weights in the emotion estimation model and weights in the rule-based fusion logic. As a result, the generation pipeline adapts across time, becoming more efficient at producing high-quality outputs, which constitutes an improvement in computer operation itself, rather than merely automating human writing.

Alternative embodiments are possible. In one variation, server executes all generative AI inference locally on its own GPU, using a pre-deployed model that has been distilled or quantized to reduce memory footprint and latency. In another variation, server delegates inference to an external inference cluster and caches responses associated with specific combinations of intermediate data and user states to avoid repeated calls for identical or similar inputs, which reduces network usage and response latency. In another variation, terminal includes limited on-device models for emotion estimation using lightweight neural networks, so that basic preference estimation can occur even when connectivity to server is temporarily limited, with later synchronization of detailed logs.

The system is thus not limited to a particular business domain. Server can treat inventory management information, product specification information, and content distribution information as instances of task-related information and can generate meeting documents, report documents, or promotional documents accordingly. Because the system relies on concrete data structures, explicit feature extraction, defined neural network architectures, and specified update procedures, and because it uses these mechanisms to enhance the efficiency and accuracy of document generation and delivery within a networked computing environment, the system provides improvements in computer functionality and information processing capabilities beyond a mere automation of human mental steps.

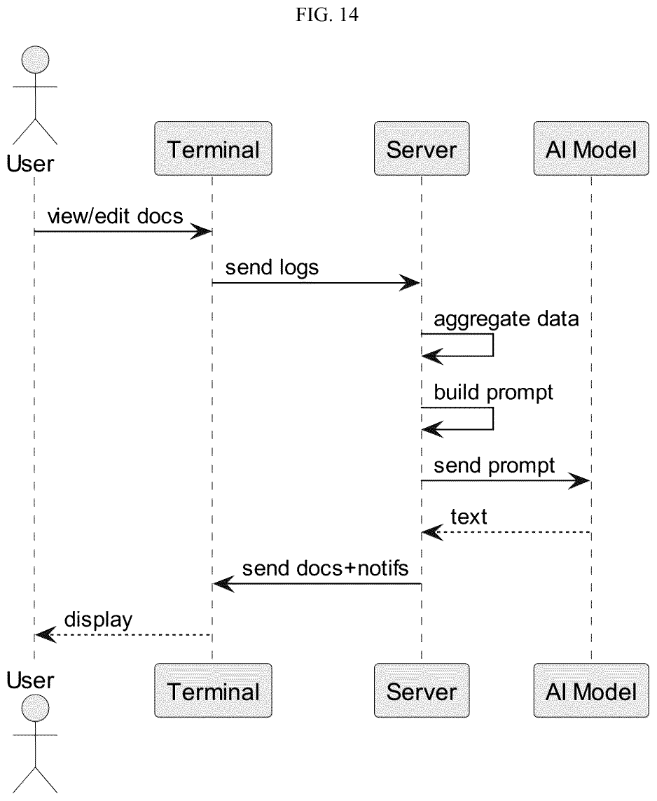

The following describes the processing flow using FIG. 14.

### Step 1:

Server acquires task-related information from multiple information sources and normalizes it.

Server receives, as input, raw digital data streams from external databases, application programming interfaces, file servers, or log streams. Server parses the raw data formats (for example, JSON records, CSV files, or text logs), validates mandatory fields, and discards malformed records. Server then maps source fields to an internal schema (for example, mapping “item_code” and “sku_id” to a unified “item_id” field) and converts date and time strings into internal timestamp objects. Server writes the normalized records as rows into relational tables in a storage device. The output of Step 1 is a set of normalized records stored in structured tables representing inventory events, content events, product information, or user interaction logs.

### Step 2:

Server aggregates and analyzes stored task-related information to generate intermediate data.

Server receives, as input, the normalized records stored in the database from Step 1, selected by a query condition such as time range, user identifier, or content category. Server loads the query result into memory and uses a table-oriented analysis library to group records by keys (for example, user, content, item, or period), compute aggregate values (such as counts, totals, averages, ratios, or moving averages), and derive additional indicators (for example, growth rates or anomaly scores). Server organizes the results into in-memory tables that contain, for each key, a compact vector of computed metrics. The output of Step 2 is intermediate data in the form of aggregated tables or feature matrices, which are ready to be embedded into prompt sentences or used as features for models.

### Step 3:

Server computes user behavior features and estimates emotional state and preference state.

Server receives, as input, user behavior history information stored in event tables, including viewing history, operation history, and editing history received from terminal. Server aggregates event records per user and per content, computing features such as number of accesses, total viewing time, number of replays, skip counts, edit distance between generated and final text, and notification open ratios. Server feeds these feature vectors into an emotion estimation model stored in memory, for example a multilayer perceptron with defined weights. Server multiplies input feature vectors by model weights, applies activation functions, and computes output scores representing emotional dimensions and preference levels. Server stores the resulting emotional state and preference state in dedicated tables keyed by user identifier. The output of Step 3 is a set of user-specific emotional and preference profiles that can be referenced during prompt construction and presentation control.

### Step 4:

Server constructs prompt sentences for a generative AI model using intermediate data and user profiles.

Server receives, as input, the intermediate data from Step 2 and the emotional state and preference state from Step 3, along with prompt templates stored in configuration. Server selects an appropriate template based on task type (for example, meeting document, report document, or promotional text) and user profile (for example, preference for detailed or concise content). Server fills template placeholders with textual summaries of intermediate data, such as “total inbound quantity: 1200 units” or “user frequently replays tracks of genre G.” Server also inserts control instructions into the prompt sentence, such as desired length, format (headings, bullet points, tables), and tone (formal, friendly), and optionally adjusts them according to emotional or preference scores. The output of Step 4 is a structured prompt sentence in natural language that explicitly includes business metrics and generation conditions, ready to be supplied to the generative AI model.

### Step 5:

Server submits the prompt sentence to the generative AI model and generates natural language content.

Server receives, as input, the constructed prompt sentence from Step 4 and model configuration parameters such as maximum output length and sampling temperature. Server tokenizes the prompt sentence into a sequence of tokens and feeds the token sequence into the generative AI model, which is implemented as a transformer-based neural network deployed on server hardware or an external inference service. Server performs, or requests, repeated matrix multiplications, attention computations, and non-linear transformations across multiple layers to obtain probability distributions over next tokens. Server samples or selects tokens step by step to form an output sequence until an end condition is met. Server then detokenizes the token sequence back into text, which constitutes the generated natural language content. The output of Step 5 is a text string containing meeting-document text, report-document text, or promotional text in human-readable language.

### Step 6:

Server formats generated natural language content into document data using templates.

Server receives, as input, the generated natural language content from Step 5 and document or screen templates stored in layout definitions. Server parses the generated text, detects structural markers such as headings, paragraphs, and lists (for example, by detecting line breaks or specific tokens), and maps these structures to template regions defined for titles, body text, and tables. Server inserts the text fragments into the corresponding placeholders, applies formatting rules (such as font size, alignment, and numbering), and generates document data in a predetermined format such as markup or a page description. Server also attaches metadata such as document identifiers, timestamps, and user identifiers. The output of Step 6 is structured document data that can be rendered by terminal as a meeting document, report document, or promotional document.

### Step 7:

Server transmits document data and notification data to terminal and controls presentation order.

Server receives, as input, the formatted document data from Step 6 and the emotional and preference states of the target user from Step 3, along with event information and recommendation information stored in the database. Server calculates a ranking score for each available document or content item based on relevance to the user's preference state and recency of the underlying data. Server orders items according to the ranking score and constructs notification data for selected items, arranging them in the determined presentation order. Server packages document data and notification data into network messages and transmits them to terminal via the communication network. The output of Step 7 is a set of delivered payloads that instruct terminal how to display the documents and which notifications to present with priority.

### Step 8:

Terminal receives and renders document data and notifications to user.

Terminal receives, as input, document data and notification data from server transmitted in Step 7. Terminal parses the document data according to the specified format, loads layout and style information, and renders headings, text, and tables on a display screen. Terminal places higher-ranked content in visually prominent positions, such as at the top of a list or in highlighted areas. Terminal also displays notification messages in a notification area or as pop-up messages, using titles and message bodies contained in the notification data. The output of Step 8 is a set of visual representations on the display that user can view, scroll, and interact with.

### Step 9:

User reviews, edits, and interacts with generated documents and notifications.

User receives, as input, the rendered documents and notifications shown by terminal in Step 8. User reads the generated meeting materials, reports, or promotional texts, and may perform operations such as scrolling, opening detailed views, approving content, or editing sentences. User may also respond to notifications by opening associated items or dismissing them. The output of Step 9 is a set of user actions, including edits, opens, and dismissals, which terminal records as interaction events.

### Step 10:

Terminal records user interaction events and transmits behavior logs to server.

Terminal receives, as input, user actions generated in Step 9, such as keystrokes, pointer clicks, and editing commands. Terminal converts these actions into structured records that include identifiers for user, document, operation type, and timestamps, and optionally additional metrics such as dwell time and cursor positions. Terminal stores these records temporarily in a local buffer and, at defined intervals or upon specific triggers, transmits the behavior logs to server over the communication network. The output of Step 10 is a stream of structured behavior log records sent to server.

### Step 11:

Server updates evaluation indices and adjusts model parameters and prompt generation rules.

Server receives, as input, the behavior log records from Step 10, along with information about previously generated documents and prompts used in Step 5. Server correlates behavior logs with documents and prompts by matching document identifiers and timestamps. Server computes evaluation indices such as acceptance rate (ratio of unedited to edited documents), average edit distance between generated and final text, notification open rate, and time-to-close metrics. Server stores these evaluation indices in metric tables and uses them to update either hyperparameters of the generative AI model (for example, sampling temperature, length penalties, or repetition penalties) or parameters of the emotion estimation model (for example, weights in the neural network) and prompt generation rules (for example, preferred template selection or phrase patterns). Server applies optimization procedures, such as gradient-based updates or heuristic rule adjustments, to improve future generations. The output of Step 11 is an updated set of model and rule parameters that influence subsequent executions of Steps 3 through 7, thereby closing the feedback loop and improving the efficiency and quality of the entire processing pipeline.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

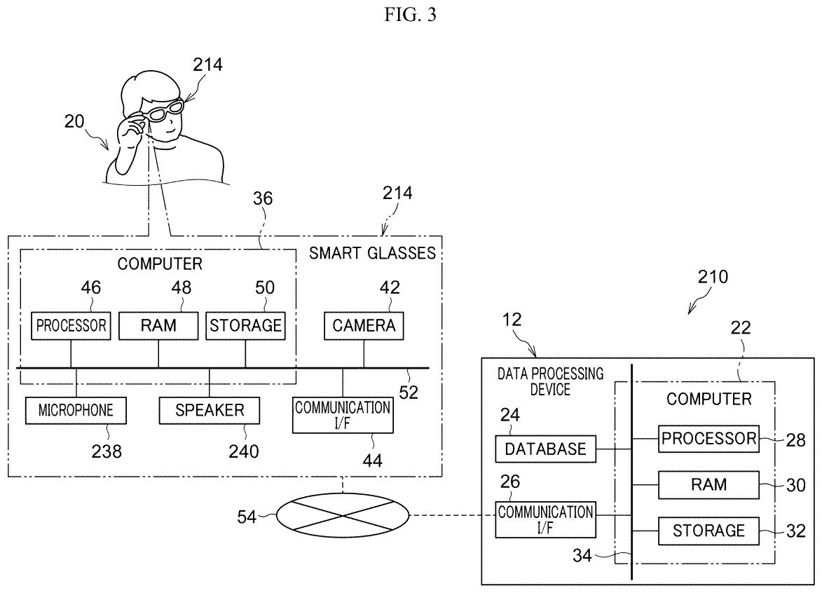

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

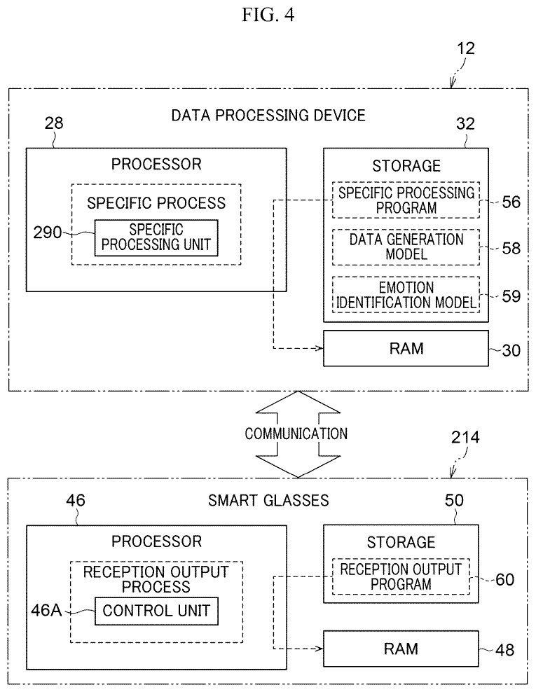

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

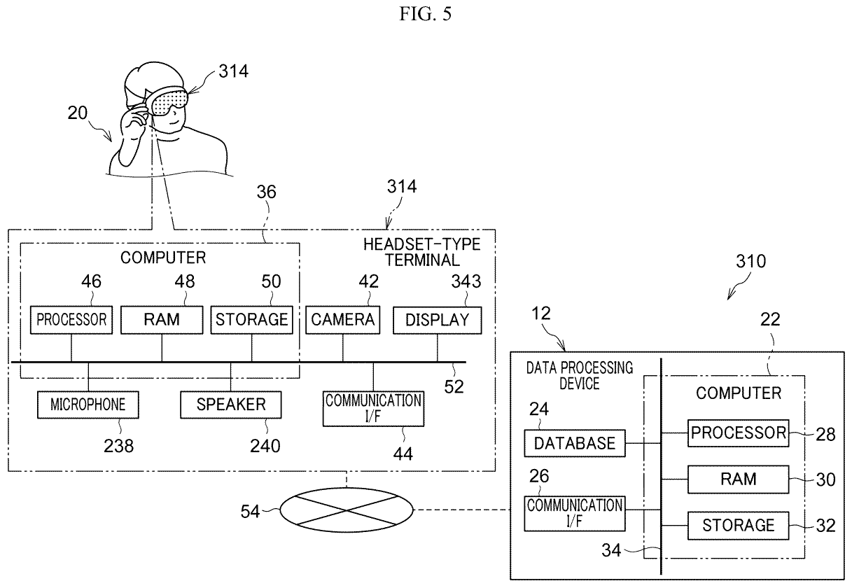

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

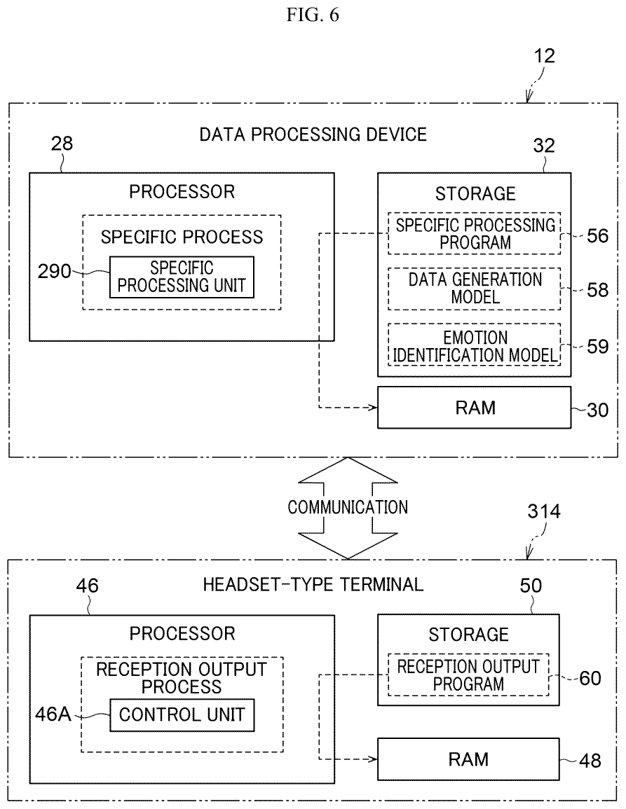

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

Fourth Exemplary Embodiment

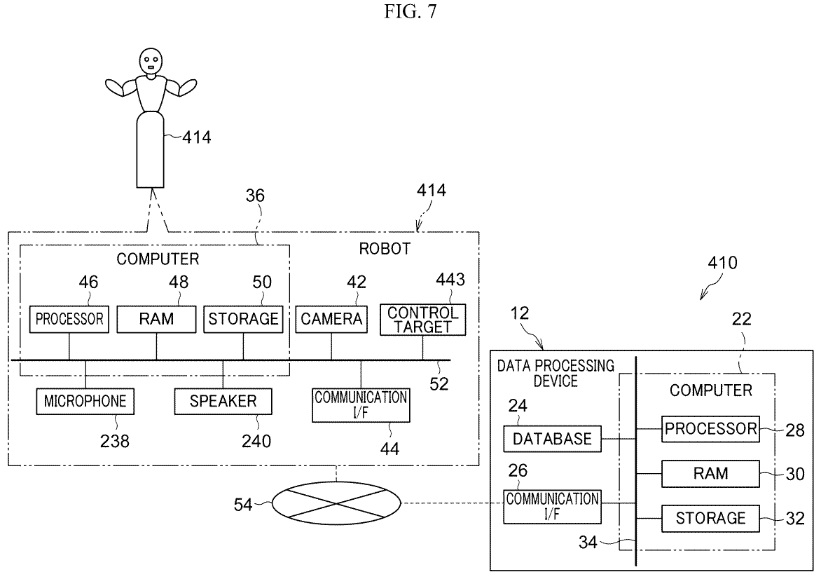

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

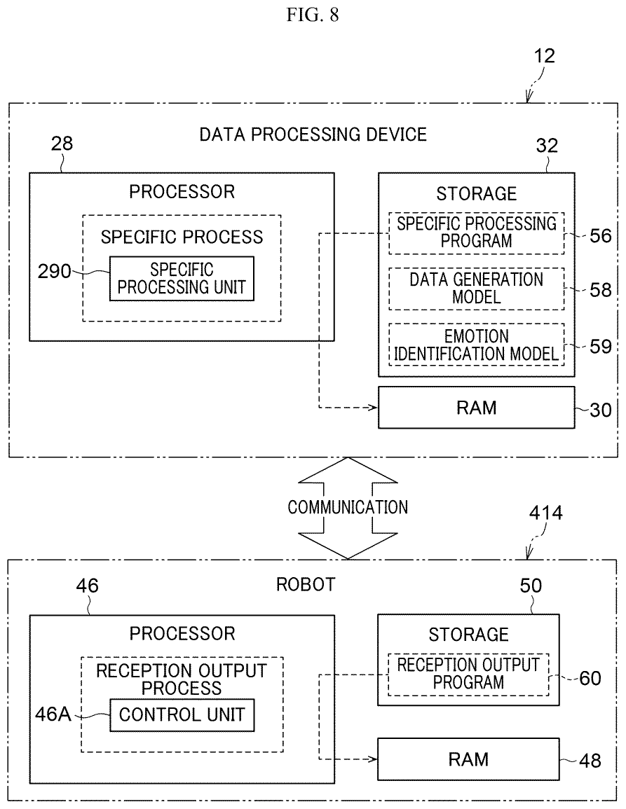

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

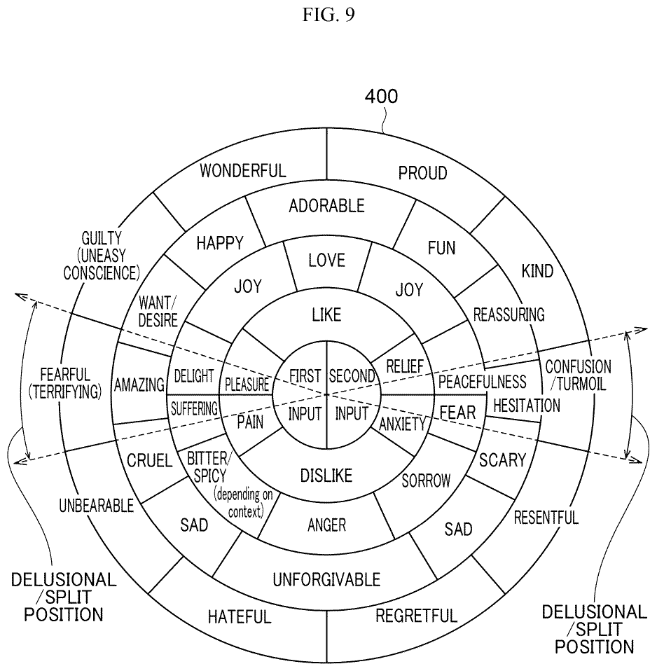

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

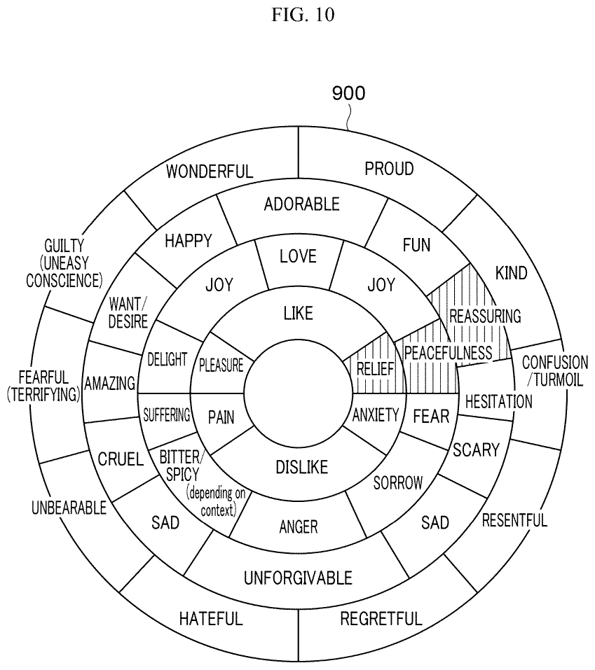

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
communicate with a plurality of information sources to acquire music-related information, and to store acquired structured data in a temporary storage resource,
analyze music-related information stored in the temporary storage resource by using a general-purpose information processing program, and normalize data item names and data structures that differ among the information sources into a unified internal data format by data-conversion processing resources, and perform organization of the music-related information by complementing missing values and removing duplicate records,
store the normalized music-related information in a relational data storage resource, and assign identification information and index information so as to accumulate the music-related information in a form suitable for subsequent retrieval,
retrieve desired music-related information from the relational data storage resource in response to an operation of a user, and extract information for constructing a prompt sentence candidate as a generation-support instruction sentence based on a retrieval result,
automatically generate a prompt sentence to be input to a generative AI model by combining the extracted information with condition information input by the user,
input the prompt sentence and corresponding music-related information to the generative AI model, and cause the generative AI model to automatically generate promotional text data by natural language generation processing, and
output the automatically generated promotional text data to a user display resource and provide an operation resource that allows the user to edit or store the promotional text data.

### Supplementary 2

The system according to supplementary 1,
wherein the processor is configured to
construct the prompt sentence to be input to the generative AI model in a template format in which contents of the music-related information accumulated in the relational data storage resource, including information items belonging to higher-level concepts of performer information, work information, and promotional description information, are automatically embedded, and to continuously generate promotional text data in a format directly usable for advertising communication or advertisement display by using the prompt sentence in the template format.

### Supplementary 3

The system according to supplementary 1,
wherein the processor is configured to
control updating of at least one generation condition of the generative AI model or automatic prompt sentence generation processing, based on a correspondence among the prompt sentence, the music-related information, and the automatically generated promotional text data recorded by the system, and based on at least one of an editing operation result by the user and an evaluation index, so as to improve text quality and operational efficiency in subsequent generation of the promotional text data.

### Application Example 1

### Supplementary 1

A system comprising a processor and a terminal device,
wherein the processor is configured to
acquire, via a communication network, structured data including new release information from a plurality of information sources, and store the structured data in a storage device,
parse the acquired structured data and normalize item names and value formats to generate an internal-format data set, and store the internal-format data set in the storage device,
perform filtering processing on the internal-format data set, based on preference information and behavioral history information of a user, to select new release information corresponding to the preference information,
construct a prompt sentence, based on an information set including the selected new release information and the preference information of the user, for instructing a generative AI model to generate a promotion text or a recommendation text,
input the constructed prompt sentence and the information set into the generative AI model, and acquire output data from the generative AI model, the output data including the promotion text or the recommendation text,
generate notification information based on the output data and the selected new release information, and transmit, in real time, the notification information to the terminal device,
receive, from the terminal device, operation information indicating a reproduction instruction operation or an evaluation operation performed by the user on the notification information, and update the preference information of the user based on the operation information, and
reflect the updated preference information in a subsequent execution of the filtering processing and in a subsequent construction of the prompt sentence,
and wherein the terminal device is configured to
receive the notification information from the processor, present the notification information on a display, accept the reproduction instruction operation or the evaluation operation from the user, and transmit the operation information to the processor.

### Supplementary 2

The system according to supplementary 1,
wherein the processor is configured to
control the prompt sentence such that the promotion text or the recommendation text automatically generated using the generative AI model is in a format usable as electronic promotional communication, advertising display, and explanatory text in meeting materials, and
generate meeting-material data by applying material data including the new release information to a document-generation template.

### Supplementary 3

The system according to supplementary 1,
wherein the processor is configured to
measure evaluation indices based on at least one of opening status information, click status information, reproduction status information, and the evaluation operation related to the notification information, and
update at least one of configuration elements of the prompt sentence to be input to the generative AI model and operation parameters of the generative AI model based on the evaluation indices, thereby improving a generation method of the promotion text or the recommendation text.

### Example 2

### Supplementary 1

A system comprising a processor,
wherein the processor is configured to
receive structured data including work-related information acquired from a plurality of information sources, and store the structured data in a storage region,
convert the stored work-related information into machine-readable intermediate data by using a data-processing program, and perform data-processing operations including set operations and attribute extraction on the intermediate data,
automatically generate a prompt sentence for input to a generative AI model on the basis of a summary of the intermediate data and configuration conditions of meeting materials, and transmit the prompt sentence to the generative AI model to obtain structural information of a meeting-material template,
automatically generate meeting materials in a spreadsheet file format on the basis of the structural information of the meeting-material template and the intermediate data, and
arrange header rows, detail rows, and summary information in the meeting materials, and distribute the automatically generated meeting materials to a terminal device via a communication network for display or editing in the terminal device.

### Supplementary 2

The system according to supplementary 1,
wherein the processor is configured to
receive the structural information of the meeting-material template obtained from the generative AI model in a machine-readable format, decompose the structural information into sheet-level and item-level definitions, and hold mapping information from the sheet-level and item-level definitions to the spreadsheet file format.

### Supplementary 3

### The System According to Supplementary 1,

wherein the processor is configured to
automatically determine configurations of graph objects and table objects to be placed in the meeting materials on the basis of summary information generated by aggregation processing on the intermediate data and on the structural information of the meeting-material template obtained from the generative AI model, and embed the graph objects and the table objects into the spreadsheet file format.

### Application Example 2

### Supplementary 1

A system comprising a processor,
wherein the processor is configured to
acquire task-related information from a plurality of information sources, convert the task-related information into a predetermined data structure, and store the converted task-related information in a storage device,
aggregate and analyze the stored task-related information by using a statistical processing program to generate intermediate data usable for creation of a meeting document, a report document, or a promotional document,
dynamically construct a prompt sentence for a generative AI model on the basis of the intermediate data and user attribute information or user behavior history information, and embed the intermediate data and analysis conditions into the prompt sentence,
input the prompt sentence to the generative AI model and cause the generative AI model to automatically generate natural language content including meeting-document text, report-document text, or promotional text,
place the automatically generated natural language content into a document template or a screen template to generate document data in a predetermined format, and provide the document data to a terminal device via a communication network,
obtain viewing history, operation history, or editing history performed by a user from the terminal device, and estimate an emotional state or a preference state of the user on the basis of the history,
control content of the prompt sentence for the generative AI model or a presentation order of the document data in accordance with the estimated emotional state or preference state, and
generate and transmit notification data to the terminal device in order to notify event information or recommendation information related to the emotional state or preference state.

### Supplementary 2

The system according to supplementary 1,
wherein the processor is configured to
configure the document data in a format usable as a meeting document, a report document, or a promotional document based on inventory management information, product specification information, or content distribution information, and include, in the notification data, recommendation information or event information in accordance with the emotional state or the preference state of the user.

### Supplementary 3

The system according to supplementary 1,
wherein the processor is configured to
calculate an evaluation index on the basis of the viewing history, the operation history, or the editing history obtained from the terminal device, and update parameters of the generative AI model or generation rules of the prompt sentence on the basis of the evaluation index, so as to adaptively improve a generation method of the natural language content.

What is claimed is:

1. A system comprising:
circuitry configured to:
acquire, via a packet-switched network, structured data records from a plurality of external information sources, each structured data record including a plurality of attribute fields;
normalize attribute field names and data formats of the structured data records into a unified internal schema by applying deterministic mapping rules;
store the normalized structured data records in a relational storage resource with identification information and index information;
retrieve, from the relational storage resource in response to a query condition, a subset of the normalized structured data records;
construct a structured prompt by embedding attribute values from the retrieved subset into a parameterized prompt template, the structured prompt including an instruction portion and condition information; and
transmit the structured prompt to a generative neural network model and acquire, from the generative neural network model, output data comprising structured output data generated by natural language generation processing.

2. The system according to claim 1, wherein the circuitry is further configured to:
detect missing attribute values in the structured data records and fill the missing attribute values using predetermined complement rules; and
compute hash values over key attribute fields of the structured data records and remove duplicate records based on comparison of the hash values.

3. The system according to claim 2, wherein the circuitry is further configured to:
construct the parameterized prompt template as a text structure including fixed instruction segments and insertion positions corresponding to the attribute fields of the normalized structured data records; and
embed the attribute values into the insertion positions to form the structured prompt.

4. The system according to claim 3, wherein the generative neural network model comprises a transformer-based architecture including an embedding layer, a plurality of self-attention layers, feedforward layers, and an output projection layer, and the circuitry is further configured to:
tokenize the structured prompt into a token sequence using a subword tokenizer; and
apply a decoding algorithm to output logits produced by the generative neural network model to generate the structured output data.

5. The system according to claim 4, wherein the circuitry is further configured to:
set generation parameters including a temperature value and a maximum token length for the generative neural network model; and
apply post-processing to the structured output data including normalization of spacing and punctuation and filtering according to constraint conditions.

6. The system according to claim 5, wherein the circuitry is further configured to:
store a correspondence record in the relational storage resource, the correspondence record associating the structured prompt, the retrieved subset of normalized structured data records, the structured output data, and at least one of an editing operation result and a performance metric datum; and
update at least one generation condition based on the correspondence record, the at least one generation condition including at least one of the generation parameters and a selection criterion of the parameterized prompt template.

7. The system according to claim 6, wherein the circuitry is further configured to:
receive, from a terminal device, evaluation feedback data including at least one of a rating value and a correction input associated with the structured output data;
aggregate the evaluation feedback data across a plurality of generation instances to compute statistics relating specific generation parameters and prompt template configurations to observed performance metric data; and
adjust the generation parameters based on the computed statistics.

8. The system according to claim 7, wherein the circuitry is further configured to:
fine-tune the generative neural network model using a training data set constructed from pairs of structured prompts and validated structured output data, the fine-tuning including computing a cross-entropy loss between predicted token distributions and target tokens and updating weight parameters using gradient-based optimization.

9. The system according to claim 8, wherein the normalized structured data records include content-related attribute fields belonging to higher-level categories of creator information, item information, and descriptive information, and the circuitry is further configured to:
embed the content-related attribute fields into the parameterized prompt template such that creator information, item information, and descriptive information are placed in designated insertion positions.

10. The system according to claim 9, wherein the circuitry is further configured to:
format the structured output data in a presentation format suitable for transmission as an electronic communication or for rendering on a display interface.

11. The system according to claim 10, wherein the circuitry is further configured to:
acquire, via the packet-switched network, new record data from the plurality of external information sources;
perform filtering processing on the new record data based on preference information and behavioral history information of a user to select a subset of new records; and
construct the structured prompt based on the selected subset and the preference information.

12. The system according to claim 11, wherein the circuitry is further configured to:
receive, from the terminal device, operation information indicating at least one of a reproduction instruction operation and an evaluation operation;
update the preference information based on the operation information by adjusting weight values in a preference vector representation; and
apply the updated preference information to subsequent filtering processing and prompt construction.

13. The system according to claim 12, wherein the circuitry is further configured to:
compute evaluation indices from the operation information, the evaluation indices including at least one of an open rate, a click-through rate, and a reproduction rate; and
adjust at least one of the generation parameters and the parameterized prompt template based on the evaluation indices.

14. The system according to claim 13, wherein the circuitry is further configured to:
generate document data by applying the normalized structured data records and the structured output data to a document-generation template; and
distribute the document data to the terminal device via the packet-switched network.

15. The system according to claim 14, wherein the circuitry is further configured to:
convert the normalized structured data records into machine-readable intermediate data by performing set operations and attribute extraction;
transmit a summary of the intermediate data and configuration conditions to the generative neural network model to obtain structural information of a document template in a machine-readable format; and
generate a multi-sheet structured document including header rows, detail rows, summary information, and embedded graph objects based on the structural information and the intermediate data.

16. The system according to claim 15, wherein the circuitry is further configured to:
accumulate operation history data of the user including viewing events, editing events, and selection events;
estimate an affective state or a preference state of the user based on the operation history data using an identification information processing model; and
adjust the instruction portion of the structured prompt based on the estimated affective state or preference state.

17. The system according to claim 16, wherein the circuitry is further configured to:
generate and transmit notification data to the terminal device, the notification data including event information or recommendation information determined based on the estimated affective state or preference state of the user; and
control a presentation order of the structured output data based on a ranking score computed from the preference state.

18. A system comprising:
circuitry configured to:
acquire, via a packet-switched network, structured data records from a plurality of external information sources;
normalize attribute field names and data formats into a unified internal schema and store the normalized structured data records in a relational storage resource with index information;
detect missing attribute values and fill the missing attribute values using complement rules, and remove duplicate records based on hash comparison of key attribute fields;
retrieve a subset of the normalized structured data records in response to a query condition;
construct a structured prompt by embedding attribute values from the retrieved subset into a parameterized prompt template including an instruction portion and condition information;
transmit the structured prompt to a generative neural network model comprising a transformer-based architecture and acquire structured output data;
store a correspondence record associating the structured prompt, the structured output data, and performance metric data; and
update generation parameters of the generative neural network model based on the correspondence record and evaluation feedback data received from a terminal device.

19. The system according to claim 18, wherein the circuitry is further configured to:
perform filtering processing on the normalized structured data records based on a preference vector of a user;
receive operation information from the terminal device and update the preference vector; and
adjust the parameterized prompt template and the generation parameters based on evaluation indices computed from the operation information.

20. A method performed by circuitry, the method comprising:
acquiring, via a packet-switched network, structured data records from a plurality of external information sources, each structured data record including a plurality of attribute fields;
normalizing attribute field names and data formats of the structured data records into a unified internal schema by applying deterministic mapping rules;
storing the normalized structured data records in a relational storage resource with identification information and index information;
retrieving, from the relational storage resource in response to a query condition, a subset of the normalized structured data records;
constructing a structured prompt by embedding attribute values from the retrieved subset into a parameterized prompt template, the structured prompt including an instruction portion and condition information; and
transmitting the structured prompt to a generative neural network model and acquiring, from the generative neural network model, output data comprising structured output data generated by natural language generation processing.
